(19) United States
(12) Patent Application Publication
(10) Pub. No.: US 2004/0039818 A1
(43) Pub. Date: Feb. 26, 2004

(54) Method for managing and changing process of client and server in a distributed computer system

(76) Inventors: Toshihiro Nakaminami, Yokohama (JP); Tetsuya Hashimoto, Tokyo (JP); Makoto Kitagawa, Huzisawa (JP); Akira Kitou, Huzisawa (JP)

Correspondence Address: MATTINGLY, STANGER & MALUR, P.C., Suite 370, 1800 Diagonal Road, AlexandrIa, VA, 22314, US

(21) Appl. No.: 10/646,845

(22) Filed: Aug. 25, 2003

Related U.S. Application Data
(63) Continuation of application No. 09/523,382, filed on Mar. 10, 2000, now abandoned.

(30) Foreign Application Priority Data
Mar. 16, 1999 (JP) 11-70623

(51) Int. Cl. G06F 15/173

(52) U.S. Cl. 709/225

(57) ABSTRACT

In a distributed system control method for controlling operation of a distributed system having a plurality of information processors connected therein, an original sender firstly creates a message addressed to the information processors in the distributed system. Secondly the original sender requests a directory information manager to search for directory information as management information for control of operations of the information processors in the distributed system. The directory information manager reads out the directory information and sends it to the original sender. The original sender controls sending operation of the created message on the basis of the directory information received from the directory information manager.

### BACKGROUND OF THE INVENTION

The present invention relates to a distributed system control method for controlling operation of a distributed system having a plurality of information processors connected therein and more particular, to a technique which can be effectively applied to the distributed system control method for changing a communication peer, communication contents and execution method without changing objects of the plurality of information processors in the system when a configuration of the distributed system was changed.

In a distributed system wherein a plurality of information processors are connected to a network to perform various types of operations in conjunction with the operations of the information processors, a directory information manager for managing the locations of software objects for execution of various types of operations in a domain is used to perform distributed system control to enable dynamic change of a communication peer in inter-object communication. Details of such a directory information manager are disclosed in three literatures, that is, ‘CORBA services: Common Object services Specification’, Naming or Trading Service (published from OMG, http://www/corba.org/); ‘An Overview of KQML: A Knowledge Query and Manipulation Language’, Facilitators (published from KQML Advisory Group, http://www.cs.umbc.edu/kqml/); and ‘LDAP-Programming Directory Enabled Applications with Lightweight Directory Access Protocol’ (written by Tim Howes, Ph. D Mark Smith, A VIACOM COMPANY).

FIG. 44 shows a schematic arrangement of a distributed system obtained on a process to reach the invention. A general operational principle of a distributed system control method using a directory information manager (searching device) will be explained with reference to FIG. 44.

Such a distributed system as shown in FIG. 44 includes a network 4400, a directory information manager 4401, an information processor 4402, a system administrator terminal 4403 and an information processor 4404. Connected to the network 4400 are the directory information manager 4401, information processor 4402, system administrator terminal 4403 and an information processor 4404. The directory information manager 4401 has a directory processing part 4405, a bus 4406 and a processor configuration information repository 4407.

FIG. 45 shows a procedure of a distributed system controlling operations. In the distributed system control method, the information processor 4402 or system administrator terminal 4403 requests the directory information manager 4401 to register processor configuration information at a step 4500, as shown by a PAD (problem analysis diagram) in FIG. 5. The processor configuration information is a pair of data in the form of a list of properties showing an ID of the information processor and features of the information processor. At a next step 4501, the directory processing part 4405 stores the processor configuration information in the processor configuration information repository 4407.

Meanwhile, the information processor 4404, when wishing to communicate with the information processor 4402, requests the directory information manager 4401 to search for the information processor 4402 at a step 4502. At a next step 4503, the directory processing part 4405 finds the information processor 4402 having coincided searching conditions from the processor configuration information repository 4407, extracts the ID of the information processor 4402 and returns it to the information processor 4404. At a next step 4504, the information processor 4404, using the ID of the information processor 4402, communicates with the information processor 4402.

In this way, the above system has an advantage that the object of especially the information processor 4404 is operated so that the individual objects and the entire system can flexibly cope with a change in the system configuration or with appearance of a new information processor.

### SUMMARY OF THE INVENTION

Although the above distributed system control method utilizing the directory information manager can find the object of the communication peer even when the system configuration was changed as mentioned above, there still remain problems.

That is, in the case where the communication peers of the respective existing information processors are already determined but it is desired to add a new information processor and for the new processor to receive a message from one of the existing information processors, it becomes necessary to change the processing contents of the information processor as the message sender. In this case, when the information processor of the message sender is originally a client, the information processor has to play a role of such a server as to offer information to the new information processor, in spite of the fact that the existing information processor is originally intended to be used as such a client as to receive information.

Further, in order to integrally process the operations of a group of objects offering a specific service or the operations of a group of objects in a domain exhibiting an object logical management range by the directory information manager, it is necessary to reboot or change the objects to change it to intended operation and, in the worst case, it becomes also necessary to rearrange the system. This imposes a considerable burden on the system administrator when he or she administrates the system for its operation and management.

Furthermore, when it is desired to add, modify a message content or add an operation based on the contents due to appearance or integration of new information processor or domain, the existing information processors must be correspondingly modified. This involves another problem that this imposes a burden on the object developer, thus disadvantageously incurring an increase in administration costs of the system using the objects.

It is therefore an object of the present invention to provide a technique which can solve the above problems, can dynamically change a communication peer, communication contents and execution method while eliminating the need for changing objects, and can centralizedly manage information processors in a distributed system.

In a distributed system control method for controlling operation of a distributed system having a plurality of information processors connected therein in accordance with the present invention, change in a communication peer, communication contents and execution method is dynamically carried out on the basis of directory information of a directory information manager.

In the present invention, a directory information repository for holding therein directory information as management information for control of operations of the information processors in the distributed system is provided in the directory information manager to centralizedly manage the information processors connected to a network and the directory information about domains and services.

When a first information processor wants to send a message to an object of a second information processor, an object-inherent operation processing part in the first information processor generates the message, and thereafter a communication managing part (which is provided in each of all the information processors has and performs processing operation based on the management information) in the information processor requests the directory information manager to search for its directory information.

The directory processing part of the directory information manager searches the directory information repository for the directory information requested by the first information processor and passes communication peer information including the searched directory information to the first information processor.

The communication managing part of the first information processor, which received the communication peer information (processor ID and directory information received together therewith), sends a message even to information processors other than the communication peer, operates in a specified execution mode, or outputs a log on the basis of the received directory information, when the first information processor wishes to communicate with the second information processor.

When the first information processor sends the message to the second information processor, the communication managing part of the first information processor adds the received directory information to the message and then sends it to the second information processor. The message sent from the first information processor is passed directly to the communication peer or indirectly thereto via the directory information manager. When the message is sent via the directory information manager, the directory information manager adds new additional information to the message or converts the message and then forwards the message. The second information processor, when receiving the message, performs processing operation based on the directory information in the message at its communication managing part, as in the first information processor.

In this way, the entire system is centralizedly managed for easy operation of the system by adding the information for management of the object operation in the message. Further, since the operation based on the directory information is carried out by the communication managing part of each information processor, the need for changing the object-inherent operation processing parts of the information processors in the network can be eliminated even when the directory information was changed.

In accordance with the distributed system control method of the present invention, as already mentioned above, when it is desired to send the message, directory information is acquired from the directory information manager and the message is sent on the basis of its directory information, so that the system can dynamically change the communication peer, communication contents and execution method without changing the objects, and the information processors in the distributed system can be centralizedly managed.

### BRIEF DESCRIPTION OF THE DRAWINGS

FIG. 1 is a schematic arrangement of a distributed system in accordance with an embodiment 1 of the present invention;

FIG. 2 schematically shows a procedure of operations in a distributed system control method of the embodiment 1;

FIG. 3 schematically shows an arrangement of a directory information manager 101 in the embodiment 1;

FIG. 4 schematically shows an arrangement of an object of an information processor 102 or 104 in the embodiment 1;

FIG. 5 is a problem analysis diagram (PAD) showing a procedure of directory information registering operations in the embodiment 1;

FIG. 6 is a PAD showing a procedure of communication peer information acquiring operations in the embodiment 1;

FIG. 7 is a PAD showing a procedure of message sending operations in the embodiment 1;

FIG. 8 is a PAD showing a procedure of message receiving operations in the embodiment 1;

FIG. 9 schematically shows an arrangement of a distributed system in accordance with an embodiment 2;

FIG. 10 is a PAD showing a procedure of distributed system controlling operations in the embodiment 2;

FIG. 11 shows a structure of processor configuration information in the embodiment 2;

FIG. 12 shows a structure of publish/subscribe information in the embodiment 2;

FIG. 13 is a PAD showing a procedure of a processor searching operations in the embodiment 2;

FIG. 14 shows a structure of a searching condition in the embodiment 2;

FIG. 15 shows structure of communication peer information in the embodiment 2;

FIG. 16 is a PAD showing a procedure of inherent or characteristic message creating operations in the embodiment 2;

FIG. 17 shows a structure of the characteristic message in the embodiment 2;

FIG. 18 is a PAD showing a procedure of communication peer information adding operations in the embodiment 2;

FIG. 19 shows a structure of a processor-addressed message in the embodiment 2;

FIG. 20 shows a structure of a send message body in the embodiment 2;

FIG. 21 is a PAD showing a procedure of message send-mode execution controlling operations in the embodiment 2;

FIG. 22 shows a structure of a publish message in the embodiment 2;

FIG. 23 shows a structure of the characteristic message in the embodiment 2;

FIG. 24 schematically shows an arrangement of a distributed system in accordance with an embodiment 3;

FIG. 25 is a PAD showing a procedure of distributed system controlling operations in the embodiment 3;

FIG. 26 shows a structure of service control information in the embodiment 3;

FIG. 27 shows a structure of a forward message in the embodiment 3;

FIG. 28 is a PAD showing a procedure of message send-mode execution controlling operations in the embodiment 3;

FIG. 29 is a PAD showing a procedure of communication peer information storing operations in the embodiment 3;

FIG. 30 shows a structure of a characteristic message in the embodiment 3;

FIG. 31 schematically shows a structure of a distributed system in accordance with an embodiment 4;

FIG. 32 is a PAD showing a procedure of distributed system controlling operations in the embodiment 4;

FIG. 33 shows a structure of a directory forward message in the embodiment 4;

FIG. 34 shows a structure of a forward message body in the embodiment 4;

FIG. 35 shows a structure of processor control information in the embodiment 4;

FIG. 36 is a PAD showing change points in communication peer information acquiring operations in the embodiment 4;

FIG. 37 is a PAD showing a procedure of message forwarding operations in the embodiment 4;

FIG. 38 schematically shows an arrangement of a distributed system in accordance with an embodiment 5;

FIG. 39 is a PAD showing a procedure of distributed system controlling operations in the embodiment 5;

FIG. 40 shows a structure of processor management information in the embodiment 5;

FIG. 41 shows a structure of a directory send message body in the embodiment 5;

FIG. 42 is a PAD showing a procedure of message receive-mode execution controlling operations in the embodiment 5;

FIG. 43 is a PAD showing a procedure of communication peer information storing operations in the embodiment 5;

FIG. 44 schematically shows an arrangement of a distributed system; and

FIG. 45 shows a procedure of controlling operations in the distributed system.

### DESCRIPTION OF THE EMBODIMENTS

(Embodiment 1)

Explanation will be made as to a distributed system control method in accordance with an embodiment 1 of the present invention for changing a communication peer, communication contents and execution method on the basis of directory information of a directory information manager.

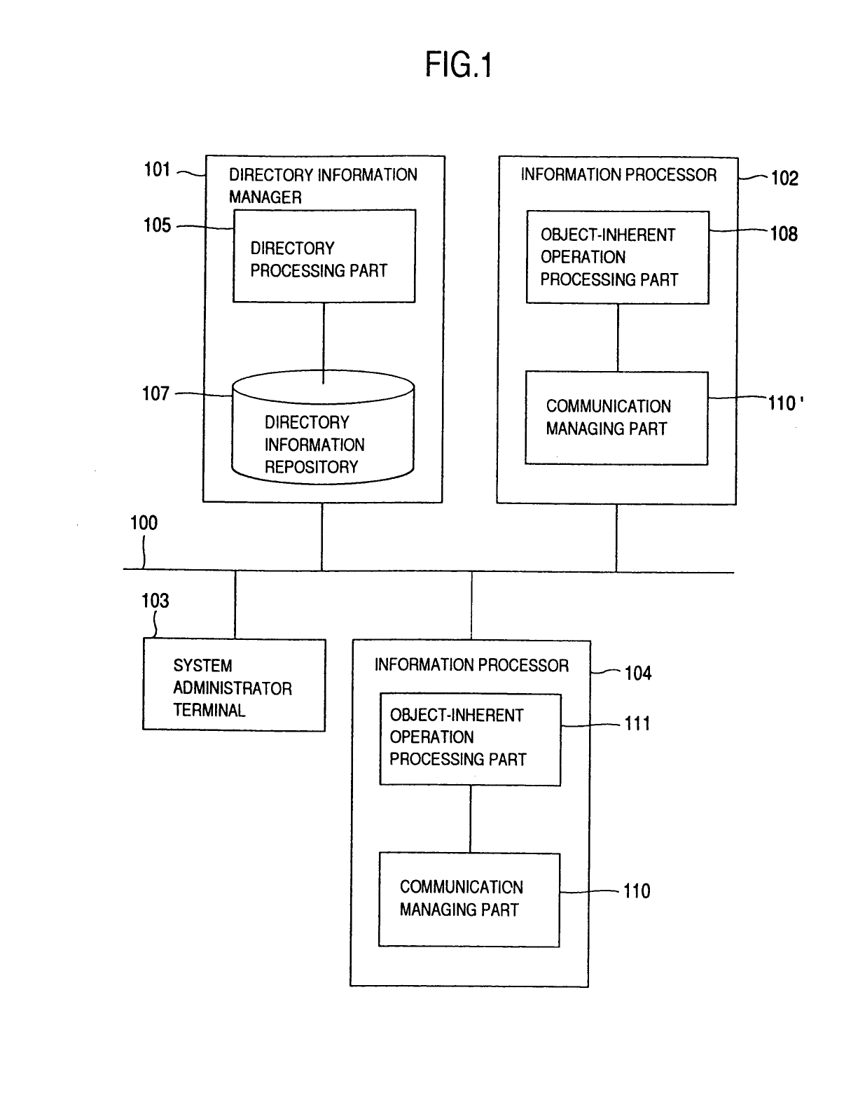

FIG. 1 schematically shows an arrangement of a distributed system in accordance with the present embodiment. As shown in FIG. 1, the distributed system of the present embodiment includes a network 100, a directory information manager 101, an information processor 102, a system administrator terminal 103, an information processor 104 and a directory information repository 107.

The network 100 is a communication medium for connection between the directory information manager 101, information processor 102, system administrator terminal 103 and information processor 104. The directory information manager 101 holds directory information as management information for control of operations of the information processors in the distributed system.

The information processor 102 is provided to offer a specific service to the information processor 104 and thus to perform message sending operation to the information processor 104 on the basis of directory information of the directory information manager 101.

The system administrator terminal 103 is used for requesting the directory information manager 101 to register the directory information. The information processor 104 is used to obtain the specific service from the information processor 102 and thus to send a message to the information processor 102 on the basis of the directory information of the directory information manager 101.

The directory information repository 107 functions to hold the directory information as management information for control of the operations of the information processors in the distributed system to centralizedly manage the information processor 102, information processor 104 and the directory information of domain and service.

The distributed system further includes a directory processing part 105, an object-inherent operation processing part 108, a communication managing part 110 and an object-inherent operation processing part 111.

The directory processing part 105 is provided to read out the directory information from the directory information repository 107 of the directory information manager 101 and to send it to a request originator of searching of the directory information. The object-inherent operation processing part 108 performs operations inherent in the information processor 102, that is, creates a message to the object of the information processor 104 and passes it to the communication managing part 110.

The communication managing part 110 requests the directory information manager 101 to search for the directory information and controls the message sending operation on the basis of the directory information received from the directory information manager 101.

The object-inherent operation processing part 111 performs operations inherent in the information processor 104, that is, creates a message to the object of the information processor 102 and passes it to the communication managing part 110.

It is assumed that a program for executing the functions of the directory processing part 105, object-inherent operation processing part 108, communication managing part 110 and object-inherent operation processing part 111 is recorded in a recording medium such as CD-ROM and then loaded in a memory for execution. In this connection, a medium for recording the program may be any medium other than the CD-ROM.

Explanation will be made as to the general operation principle of the distributed system control method of the present embodiment by referring to FIG. 1. The present embodiment is intended to dynamically find a communication peer to the object and to realize the communication with the peer, in particular, without modifying the object per se of the information processor 104, and also to perform centralized object management on a service or domain basis.

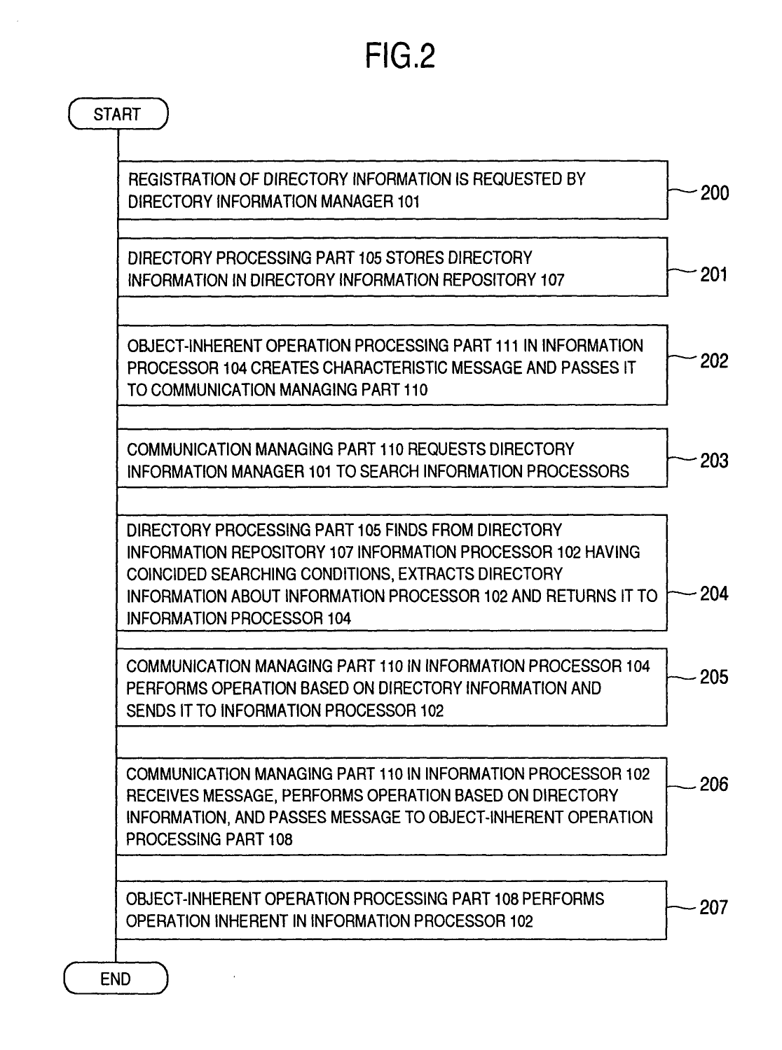

FIG. 2 schematically shows a procedure of operations in the distributed system control method of the present embodiment. In the present embodiment, as shown by a PAD in FIG. 2, the information processor 102 or system administrator terminal 103 requests the directory information manager 101 to register directory information at a step 200. The operation of the step 200 will be referred to as the directory information registering operation hereinafter. Details of the directory information will be made specific from the description of common operations of the present embodiment to be explained later. At a next step 201, the directory processing part 105 stores the directory information in the directory information repository 107.

Meanwhile, at a step 202, the object-inherent operation processing part 111 of the information processor 104 creates a message inherent in the object and passes it to the communication managing part 110. At a next step 203, the communication managing part 110 requests the directory information manager 101 to search the information processor 102.

At a next step 204, the directory processing part 105 finds the information processor 102 which has coincided the searching conditions from the directory information repository 107, extracts directory information corresponding to the information processor 102, and returns it to the information processor 104. The operation of the step 204 will be referred to as the communication peer information acquiring operation, hereinafter.

At a step 205, the communication managing part 110 of the information processor 104 performs processing operation based on the directory information and sends a message to the information processor 102. The operations of the steps 202, 203 and 205 will be referred to as the message sending operations, hereinafter.

At a next step 206, the communication managing part 110 of the information processor 102 receives the message, performs processing operation based on the directory information, and passes a message to the object-inherent operation processing part 108. At a step 207, the object-inherent operation processing part 108 performs operation inherent in the information processor 102. The operations of the steps 206 and 207 will be referred to as the message receiving operations, hereinafter.

In this way, when a search request is issued from the information processor 104 to the directory information manager 101, the directory information is returned as a searched result so that the directory information manager 101 can centralizedly manage and control objects on a service or domain basis. Further, since the communication processing parts of the objects are separated from parts inherent in the objects, the need for changing contents of the object-inherent parts can be eliminated for a change of the communication peer or communication processing caused by a change in the system configuration or by addition of a new information processor.

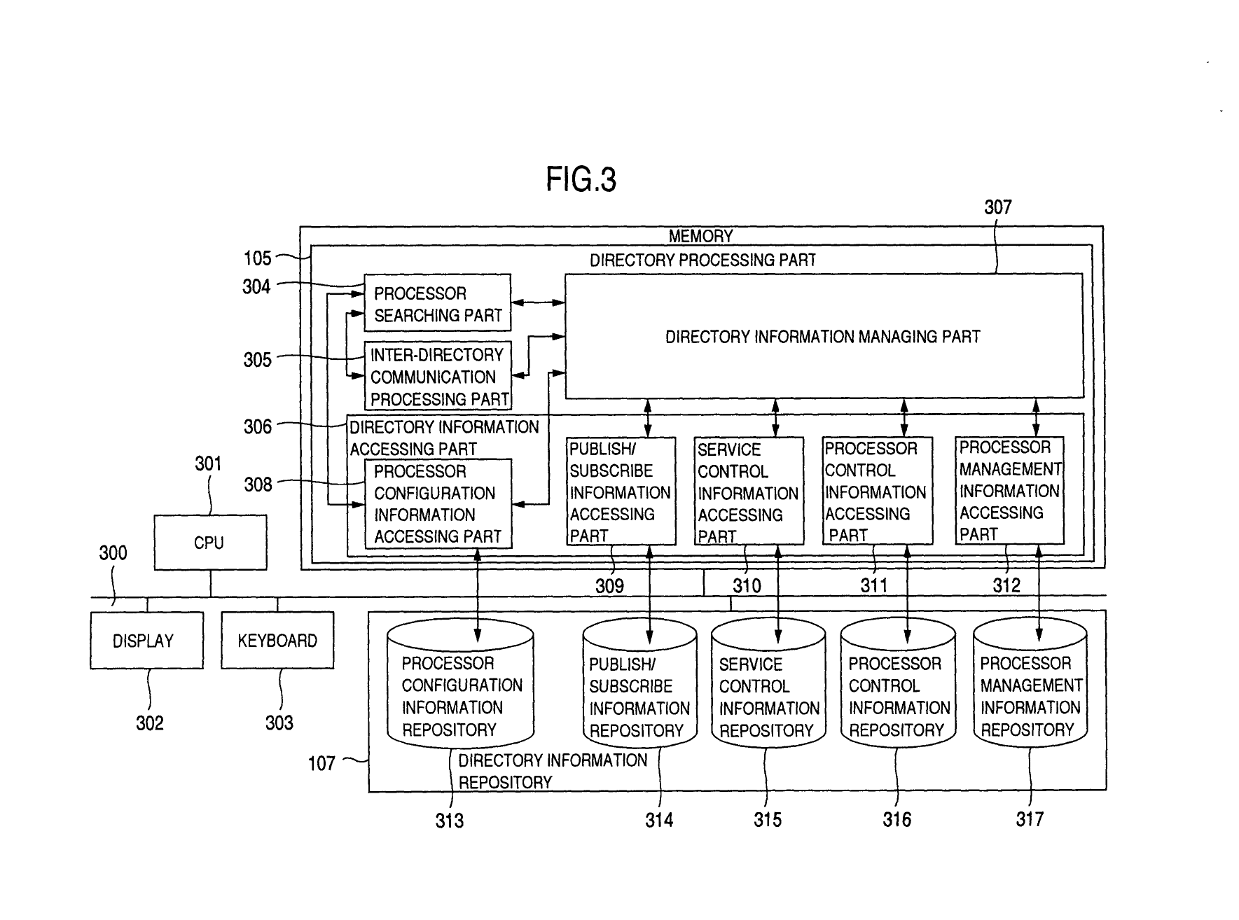

FIG. 3 schematically shows a structure of the directory information manager 101 in the present embodiment. The directory information manager 101 has a bus 300, a CPU 301, a display 302, a keyboard 303, the directory processing part 105, and the directory information repository 107. Connected to the bus 300 are the CPU 301, display 302, keyboard 303, a memory in which the directory processing part 105 is loaded, and the directory information repository 107.

The directory information repository 107 has a processor configuration information repository 313, a publish/subscribe information repository 314, a service control information repository 315, a processor control information repository 316 and a processor management information repository 317.

The directory processing part 105 has a processor searching part 304, an inter-directory communication processing part 305, a directory information accessing part 306 and a directory information managing part 307. The directory information accessing part 306 has a processor configuration information accessing part 308, a publish/subscribe information accessing part 309, a service control information accessing part 310, a processor control information accessing part 311 and a processor management information accessing part 312.

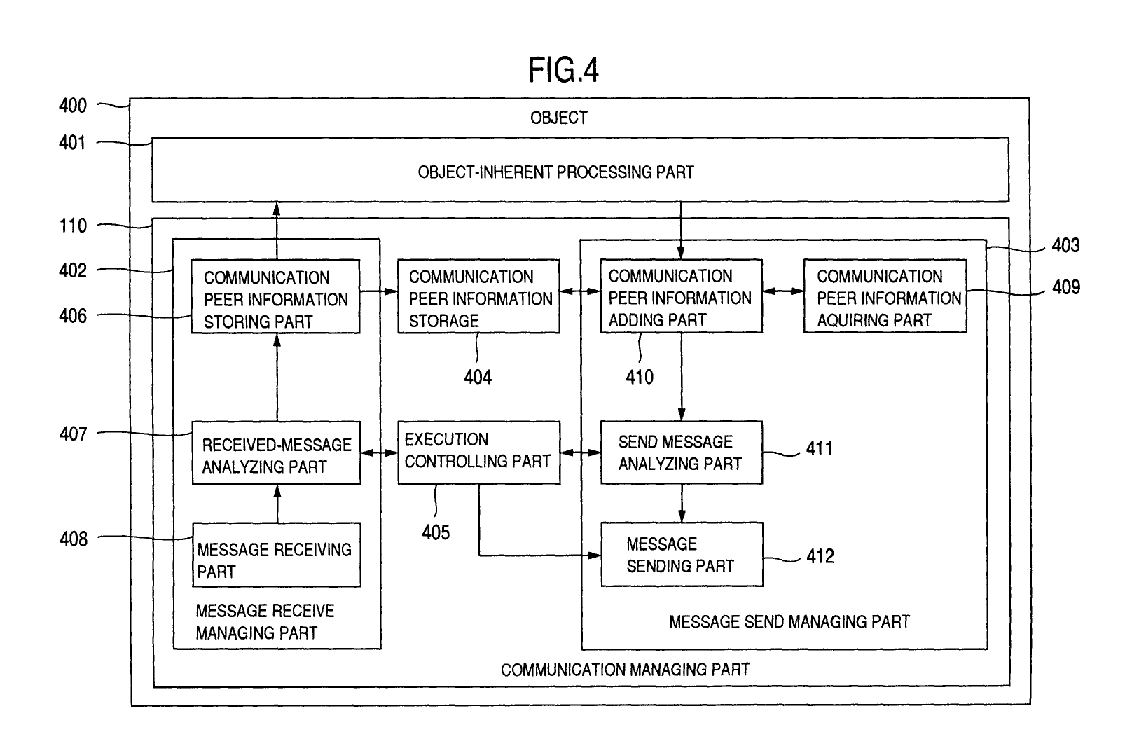

Schematically shown in FIG. 4 is a structure of the information processor 102 or 104 in the present embodiment. The object of the information processor 102 or 104 has such a structure as shown by an object 400.

The object 400 includes an object-inherent processing part 401 and a communication managing part 110. The communication managing part 110 has a message receive managing part 402, a communication peer information storage 404, an execution controlling part 405 and a message send managing part 403.

The message receive managing part 402 has a communication peer information storing part 406, a received-message analyzing part 407 and a message receiving part 408. The message send managing part 403 has a communication peer information acquiring part 409, a communication peer information adding part 410, a send message analyzing part 411 and a message sending part 412.

Explanation will next be made as to operations common to the directory information registering operation, communication peer information acquiring operation, message sending operation and message receiving operation.

FIG. 5 is a PAD showing a procedure of directory information registering operations in the present embodiment. As shown by the PAD in FIG. 5, in the directory information registration mode, the information processor 102 or system administrator terminal 103 creates directory information on an object to be registered, that is, processor configuration information, publish/subscribe information, service control information, processor control information and/or processor management information on an information processor or service basis at a step 500.

In this conjunction, the processor configuration information as well as the publish/subscribe information indicative of other information processors receiving a message transferred between the information processors performing a specific service, the service control information specifying the processing execution method and/or execution record sampling method for the information processors belonging to the specific service, the processor control information specifying the message processing method or information to be added to the message, and/or the processor management information indicative of states of the information processors will be clear from the description of operations of other embodiments to be explained later.

At a next step 501, the information processor 102 or system administrator terminal 103 requests the directory information accessing part 306 to register the created processor configuration information and publish/subscribe information, service control information, processor configuration information or processor management information.

At a next step 502, the operation of the step 502 is repeated by the number of entries (each of which is an information unit with an object ID, service name, etc. as a key) of the processor configuration information, publish/subscribe information, service control information, processor control information or processor management information obtained at the step 501 on a processor-ID or service name basis to perform the operation of a step 503.

At the step 503, the directory information accessing part 306 registers the entries of the processor configuration information, publish/subscribe information, service control information, processor control information or processor management information through the processor configuration information accessing part 308, publish/subscribe information accessing part 309, service control information accessing part 310, processor control information accessing part 311 or processor management information accessing part 312 obtained at the step 501 in the processor configuration information repository 313, publish/subscribe information repository 314, service control information repository 315, processor control information repository 316 or processor management information repository 317.

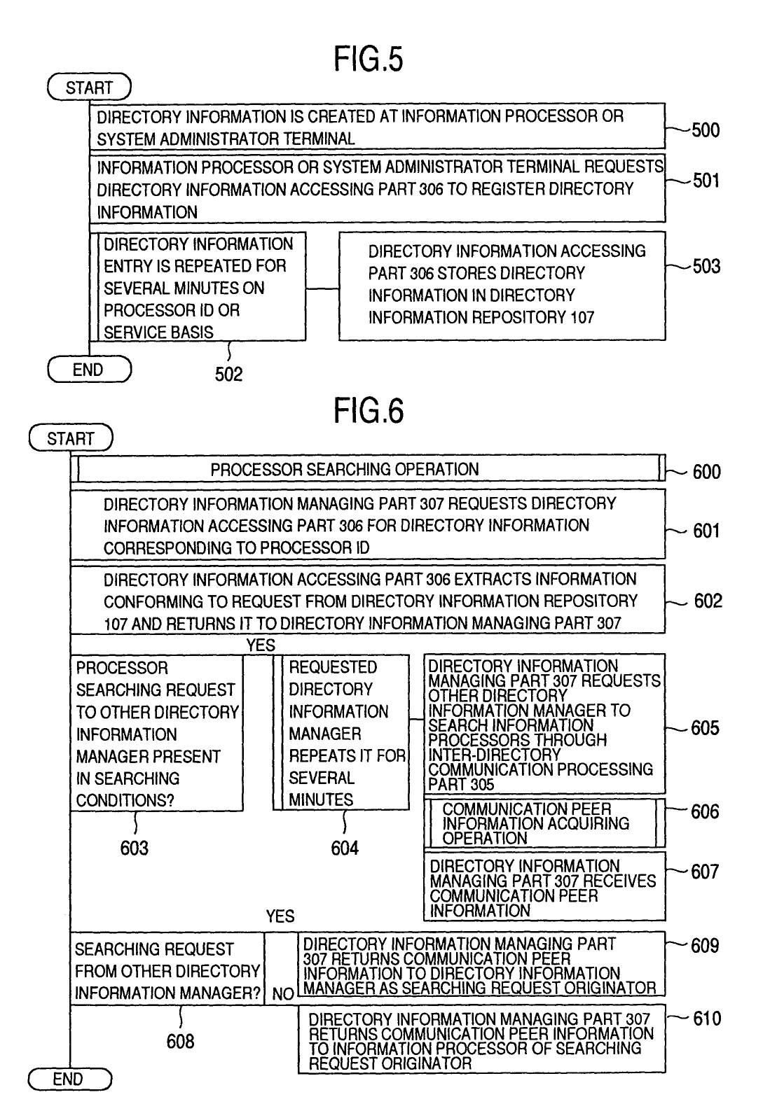

FIG. 6 is a PAD showing a procedure of communication peer information acquiring operations in the present embodiment. As shown by the PAD in FIG. 6, when it is desired to acquire communication peer information, processor searching operation is carried out at a step 600 to obtain a list of processor Ids. The processor searching operation will become clear from the description of the operation of another embodiment to be explained later.

At a step 601, the directory information managing part 307 requests the directory information accessing part 306 to find the communication peer information corresponding to the processor ID list obtained at the step 600. The communication peer information will become clear from the description of the operations of other embodiments to be explained later.

At a next step 602, the directory information accessing part 306 extracts the directory information from the directory information repository 107 and passes the directory information to the directory information managing part 307 as the communication peer information.

At a step 603, it is judged whether or not there is a search request of the information processor to other directory information managers in the searching conditions. In the presence of such a search request to other directory information managers in the searching conditions, the operation is repeated at a step 604 by the number of directory information managers to be searched for to perform the operations of steps 605 to 607.

There are other information processor searching request methods to the other directory information managers. That is, first of the methods is to specify the other directory information managers to be searched by a hop count number indicative of a link depth and to decrement the hop count each time the search request is requested to the other directory information manager. A second method is to specify the names of the other directory information managers to be searched. A third method is to specify the other directory information managers to be searched by link properties.

At a step 605, the directory information managing part 307 requests the other directory information manager to be searched to search the information processors through the inter-directory communication processing part 305. At a next step 606, the communication peer information acquiring operation as the present operation is recursively carried out. And at a step 607, the directory information managing part 307 accepts the communication peer information.

Lastly at a step 608, it is judged whether or not the present processing request is from the other directory information manager. If the request is from the other directory information manager, then the directory information managing part 307 returns at a step 609 the communication peer information acquired at the step 602 or 607 to the directory information manager as the request originator. If the request is not from the other directory information manager, then the directory information managing part 307 returns at a step 610 the communication peer information acquired at the step 602 or 607 to the request originator.

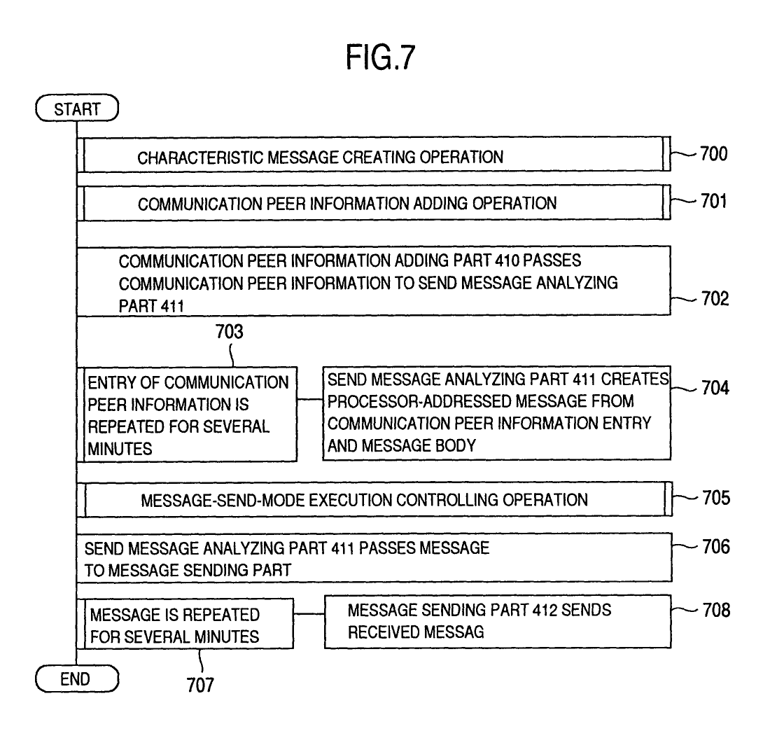

FIG. 7 is a PAD showing a procedure of message sending operations in the present embodiment. As shown by the PAD in FIG. 7, in the message send mode, inherent or characteristic message creating operation is carried out at a step 700, and communication peer information adding operation containing the communication peer information acquiring operation is carried out at a step 701. The characteristic message, characteristic message creating operation and communication peer information adding operation will become clear from the description of the operation of another embodiment to be explained later.

At a next step 702, the communication peer information adding part 410 passes the characteristic message and communication peer information to the send message analyzing part 411. The operation is repeated at a step 703 by the number of entries of the communication peer information on a processor ID basis to perform the operation of a step 704.

At the step 704, the send message analyzing part 411 creates a processor-addressed message on the basis of the entry of the communication peer information and a message body in the characteristic message. The contents of the processor-addressed message will become clear from the description of the operation of the other embodiment to be explained later.

Message send mode execution controlling operation is carried out at a next step 705, and the send message analyzing part 411 passes the processor-addressed message to the message sending part 412 at a step 706. The message send mode execution controlling operation will become clear from the description of the operation of the other embodiment to be explained later.

The operation is repeated at a next step 707 by the number of processor-addressed messages to perform the operation of a step 708. At the step 708, the message sending part 412 sends to the information processor as the communication peer the processor-addressed message received from the send message analyzing part 411 or execution controlling part 405.

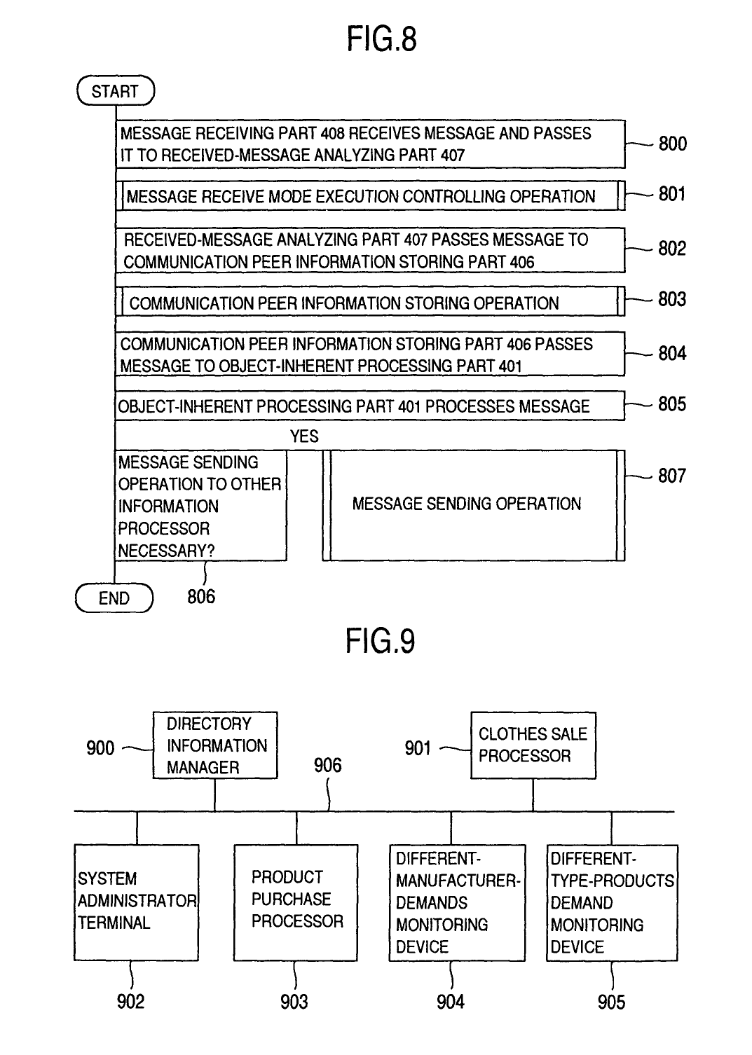

FIG. 8 is a PAD showing a procedure of message receiving operations in the present embodiment. As shown by the PAD in FIG. 8, in the message receive mode, the message receiving part 408 receives at a step 800 the processor-addressed message sent from the other information processor and passes the processor-addressed message to the received-message analyzing part 407.

The message receive mode execution controlling operation is carried out at a next step 801, and the received-message analyzing part 407 passes at a step 802 the processor-addressed message to the communication peer information storing part 406. The message receive mode execution controlling operation will become clear from the description of the operation of the other embodiment to be explained later.

The communication peer information storing operation is carried out at a next step 803, and the communication peer information storing part 406 passes at a step 804 the processor-addressed message to the object-inherent processing part 401. The communication peer information storing operation will become clear from the description of the operation of the other embodiment to be explained later.

At a next step 805, the object-inherent processing part 401 processes the processor-addressed message. And it is judged at a step 806 whether or not the message sending operation to the other information processor is necessary. If the message sending operation to the other information processor is necessary, then the message sending operation is carried out at a step 807.

As has been explained above, in accordance with the distributed system control method of the present embodiment, at the time of sending a message, the directory information is acquired from the directory information manager and the message is sent based on the directory information, so that the communication peer, communication contents and execution method can be dynamically changed without needing to change the object and thus the information processors in the distributed system can be centralizedly managed.

(Embodiment 2)

Explanation will next be made as to a distributed system control method in accordance with an embodiment 2 wherein a message of a product purchase processor communicating with a clothes sale processor or with various types of monitoring devices is sent also to another monitoring device newly connected to a network.

FIG. 9 schematically shows an arrangement of a distributed system according to the present embodiment. As shown in FIG. 9, the distributed system of the present embodiment includes a directory information manager 900, a clothes sale processor 901, a system administrator terminal 902, a product purchase processor 903, a different-manufacturer-demands monitoring device 904, a different-type-products demand monitoring device 905 and a network 906. Connected to the network 906 are the directory information manager 900, clothes sale processor 901, system administrator terminal 902, product purchase processor 903, different-manufacturer-demands monitoring device 904 and different-type-products demand monitoring device 905.

In the present embodiment, since a message sent from the product purchase processor 903 to the clothes sale processor 901 is sent also to the different-manufacturer-demands monitoring device 904 or different-type-products demand monitoring device 905 through the publish/subscribe operation, the other monitoring devices can grasp the demand of the product purchase processor 903.

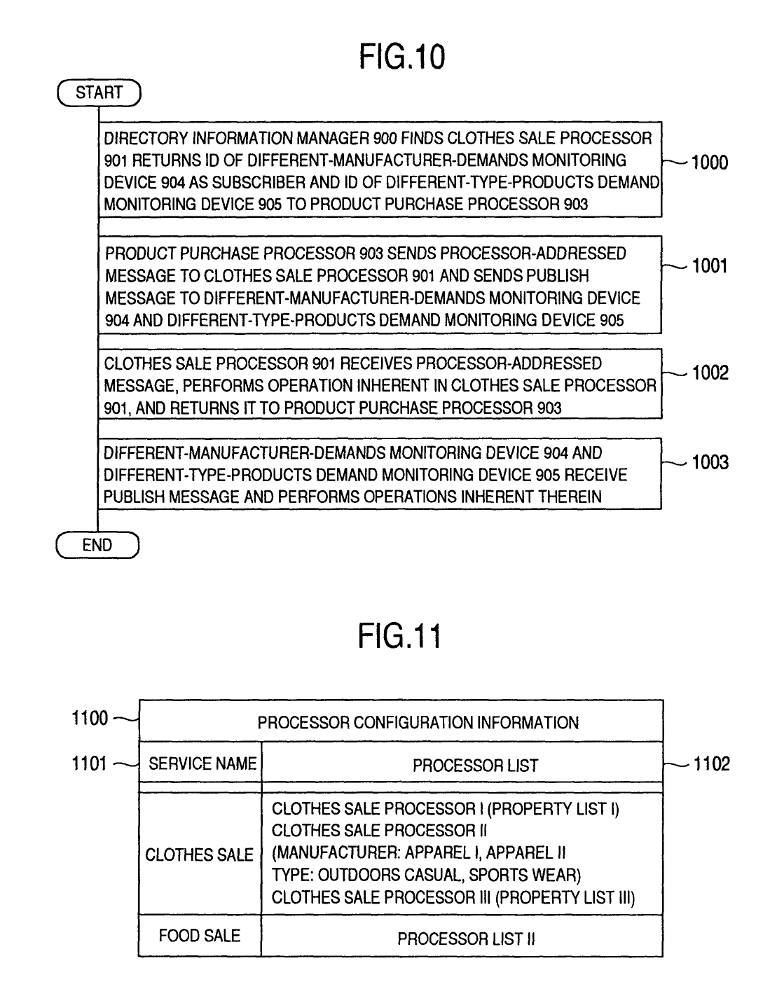

FIG. 10 is a PAD showing a procedure of distributed system controlling operations in the present embodiment. In the entire operations of the present embodiment, after the directory information registering operations similar to the steps 200 and 201 in the PAD of FIG. 2 are carried out, the directory information manager 900 finds the clothes sale processor 901 having coincided searching conditions and returns IDs of the different-manufacturer-demands monitoring device 904 and different-type-products demand monitoring device 905 as a service subscriber, to the product purchase processor 903 at a step 1000 as shown by the PAD in FIG. 10.

At a next step 1001, the product purchase processor 903 sends a processor-addressed message to the clothes sale processor 901 and sends a publish message to the different-manufacturer-demands monitoring device 904 and different-type-products demand monitoring device 905. The publish message will be explained later.

At a next step 1002, the clothes sale processor 901 receives the processor-addressed message, performs operations inherent in the clothes sale processor 901, and returns it to the product purchase processor 903. At a last step 1003, the different-manufacturer-demands monitoring device 904 and different-type-products demand monitoring device 905 receive the publish message and perform operations inherent in the respective devices.

Explanation will then be made, as publish/subscribe operations, as to the directory information registering operation, communication peer information acquiring operation, message sending operation by the product purchase processor 903, message receiving operation by the clothes sale processor 901, message response operation by the clothes sale processor 901, message receiving operation by the different-manufacturer-demands monitoring device 904, and message receiving operation by the different-type-products demand monitoring device 905.

In the directory information registering operation, its operation is basically the same as the common operation shown by the PAD of FIG. 5. The directory information at the step 500 includes processor configuration information and publish/subscribe information, and the processor configuration information has such a structure as shown in FIG. 11.

FIG. 11 shows a structure of the processor configuration information in the present embodiment. An entry is a pair of data which as a service name 1101 as a key and a processor list 1102 as a value. For example, the first entry is a pair of data which has “clothes sale” as the service name 1101 and has “clothes sale processor I (property list I), clothes sale processor II (manufacturer: apparel 1, apparel 2, type: outdoors casual, sports wear, clothes sale processor III (property list III)” as the processor list 1102, with IDs of these processors used as keys. The second entry is a pair of data which has “food sale” as the service name 1101 and has “processor list II” as the processor list 1102. In this case, “clothes sale processor II” corresponds to a processor ID for the clothes sale processor 901.

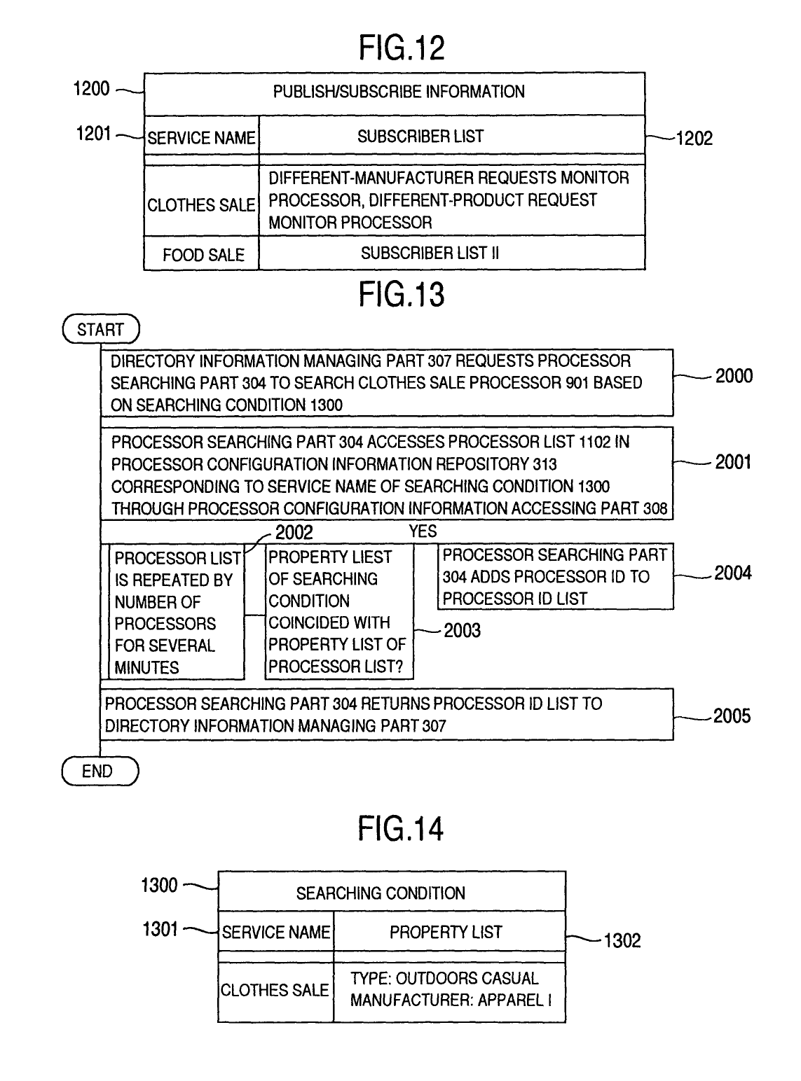

FIG. 12 shows a structure of publish/subscribe information in the present embodiment. An entry is a pair of data which has a service name 1201 as a key and a subscriber list 1202 as a value. In the illustrated example, for example, the first entry is a pair of data which has “clothes sale” as the service name 1201 and has “different-manufacturer-demands monitor processor, different-product-type-demands monitor processor” as the subscriber list 1202 with a value of a subscriber ID. The second entry has “food sale” as the service name 1201 and has “subscriber list II” as the subscriber list 1202.

FIG. 13 is a PAD showing a procedure of processor searching operations in the present embodiment. In the communication peer information acquiring operation, its operation is basically the same as the common operation shown in the PAD of FIG. 6. With regard to the processor searching operation of the step 600, the directory information managing part 307 requests the processor searching part 304 to search the clothes sale processor 901 according to its searching conditions at a step 2000 as shown in the PAD of FIG. 13.

FIG. 14 shows a structure of searching conditions in the present embodiment. A searching condition 1300, which has such a structure as shown in FIG. 14, is a pair of data which has a service name 1301 as a key and has a property list 1302 as a value. In the case of FIG. 14, for example, the service name 1301 is “clothes sale” and the property list 1302 is “type: outdoors casual, manufacturer: apparel I”.

At a next step 2001, the processor searching part 304 accesses the processor list 1102 in the processor configuration information repository 313 corresponding to the service name 1301 in the searching condition 1300 through the processor configuration information accessing part 308. In the present embodiment, since the service name 1301 is “clothes sale”, the processor searching part 304 makes access to the first processor of the processor list 1102.

The operation is repeated at a next step 2002 by the number of processor IDs in the processor list to perform operation of a step 2003. At the step 2003, it is judged whether or not the contents of the property list 1302 in the searching condition 1300 are all contained in the properties of the processor list 1102. If the entries of the property list 1302 in the searching condition 1300 are all contained in the properties of the processor list 1102, then the processor searching part 304 adds at a step 2004 the corresponding processor ID corresponding to the list of the processor ID. Finally, at a step 2005, the processor searching part 304 returns the processor ID list and the subscriber list 1202 corresponding to the service name 1301 as the communication peer information.

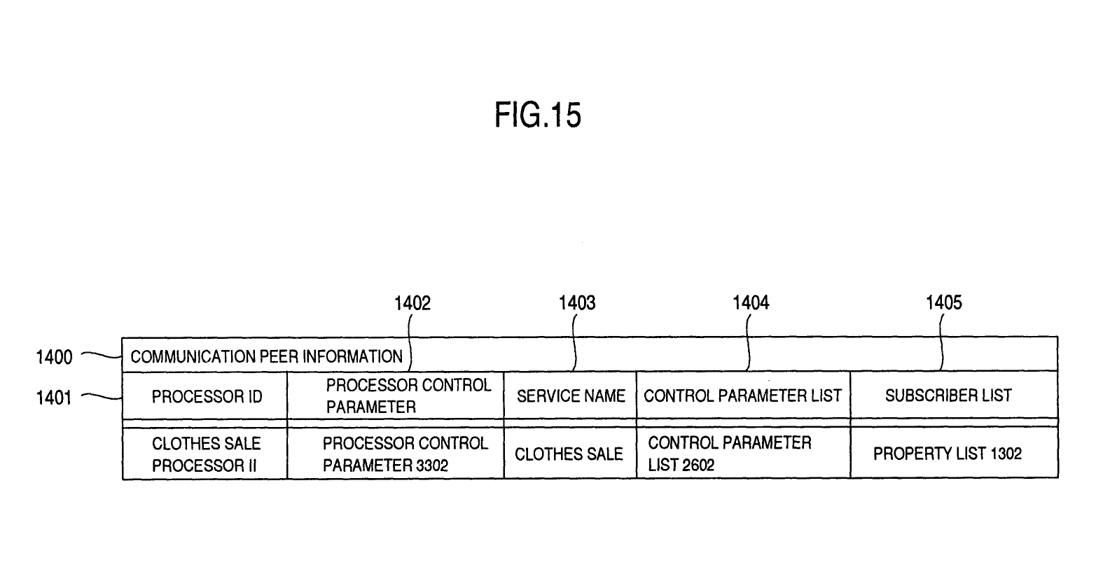

FIG. 15 shows a structure of communication peer information in the present embodiment. The communication peer information obtained at a step 602 has such a structure as shown in FIG. 15, that is; a pair of data having a processor ID 1401 and a processor control parameter 1402 depending upon the processor ID 1401 as values, and three elements of set data of a service name 1403, a control parameter list 1404 depending upon the service name 1403 and a subscriber list 1405 as values.

In the set data of the illustrated example, for example, the processor ID 1401 is “clothes sale processor II” as an ID of the clothes sale processor 901, the processor control parameter 1402 is “processor control parameter 3302”, the service name 1403 is “clothes sale”, the control parameter list 1404 is “control parameter list 2602”, and the subscriber list 1405 is “subscriber list 1202”.

Communication peer information 1400 obtained in the present embodiment includes the processor ID 1401, service name 1403 and subscriber list 1405 among the aforementioned information. The processor control parameter 3302 and control parameter list 2602 will become clear from the description of the operation of the other embodiment to be explained later.

The message sending operation of the product purchase processor 903 is basically the same as the common operation shown in the PAD of FIG. 7 and a characteristic message is first created.

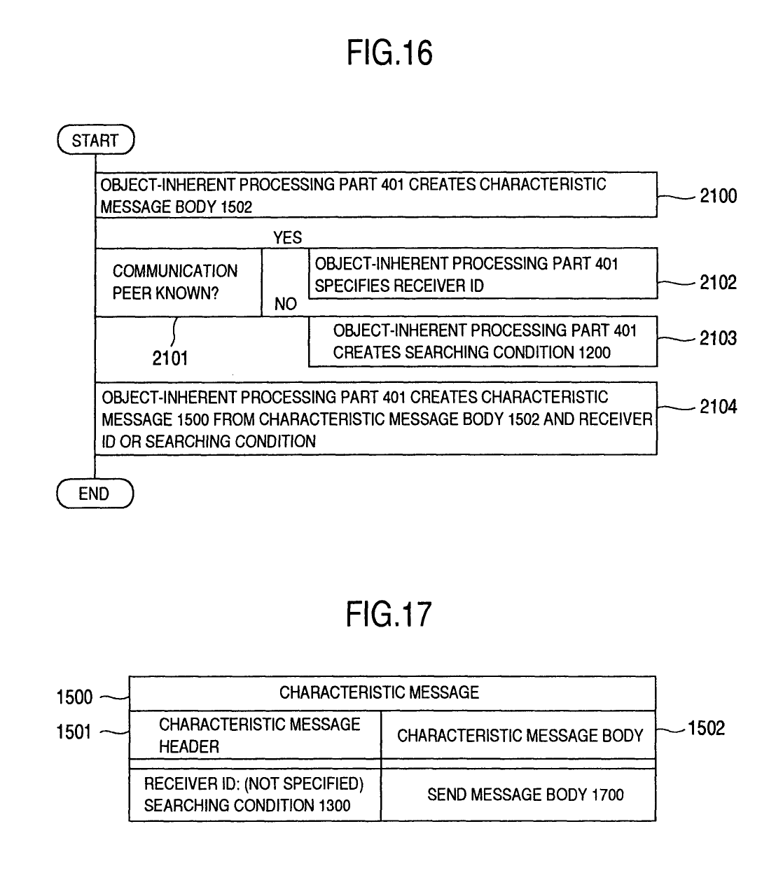

FIG. 16 is a PAD showing a procedure of characteristic message creating operations in the present embodiment. With respect to the characteristic message creating operation at the step 700, the object-inherent processing part 401 creates at a step 2100 a characteristic message body as shown by the PAD in FIG. 16.

FIG. 17 shows a structure of a characteristic message in the present embodiment. A characteristic message body 1502 created at the step 2100 is a message containing a header creatable by the information processor 104 and a content uniquely created by the information processor 104. Described in the header, for example, are “product purchase processor” designated as a sender ID and conditions of product information demanded by the information processor 104.

At a next step 2101, it is judged whether or not the communication destination peer is known. If the communication peer is known, then the operation of a step 2102 is carried out; while if the communication peer is unknown, then the operation of a step 2103 is carried out. The object-inherent processing part 401 designates a receiver ID at the step 2102, and creates the searching condition 1300 at the step 2103.

At a last step 2104, the object-inherent processing part 401 creates a characteristic message 1500 based on the characteristic message body 1502 and the receiver ID or searching condition 1300.

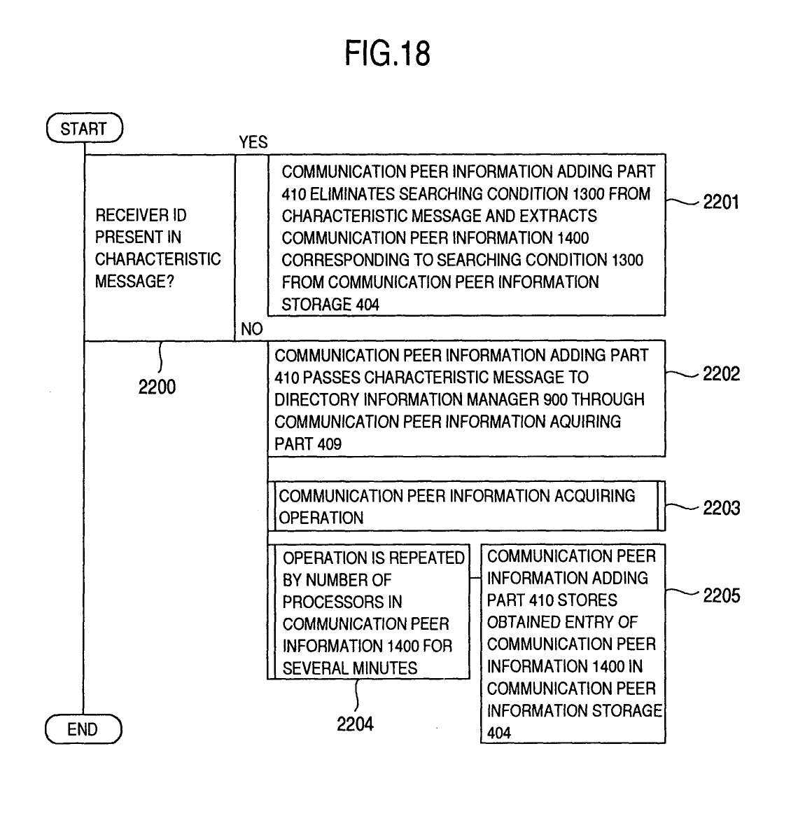

FIG. 18 is a PAD showing a procedure of communication peer information acquiring operations in the present embodiment. With respect to the communication peer information acquiring operation of the step 701, wherein it is judged at a step 2200 whether or not the receiver ID is present in the characteristic message 1500 as shown by the PAD of FIG. 18.

If there is a receiver ID in the characteristic message 1500, then the operation of a step 2201 is carried out; whereas, if the receiver ID is absent in the characteristic message 1500, then the operations of steps 2202 to 2204 are carried out. In the case of the present embodiment, since there is no receiver ID, the operations of the steps 2202 to 2204 are carried out.

At the step 2201, the communication peer information adding part 410 eliminates the searching condition 1300 from the characteristic message 1500 and extracts the communication peer information 1400 corresponding to the searching condition 1300 from the communication peer information storage 404.

Meanwhile, at the step 2202, the communication peer information adding part 410 passes the characteristic message 1500 to the directory information manager 900 via the communication peer information acquiring part 409.

The communication peer information acquiring operation is carried out at the next step 2203, and the operation is repeated at the step 2204 by the number of processor IDs in the communication peer information 1400 to perform the operation of a step 2205.

At the step 2205, the communication peer information adding part 410 stores in the communication peer information storage 404 the entry of the communication peer information 1400 obtained at the step 2203.

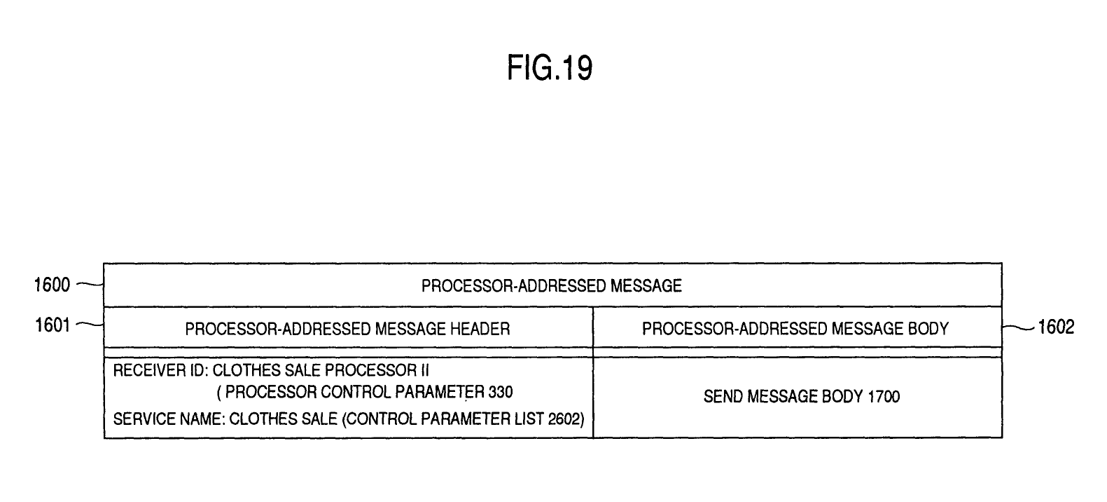

FIG. 19 shows a structure of the processor-addressed message in the present embodiment. The processor-addressed message at the step 704 has such a structure as shown in FIG. 19, that is, has a processor-addressed message header 1601 and a processor-addressed message body 1602; the header 1601 containing a pair of data having a receiver ID as a key and a processor control parameter as a value and a pair of data having a service name as a key and a control parameter list as a value.

In the case of FIG. 19, for example, the receiver ID is “clothes sale processor II” for an ID of the clothes sale processor 901, the processor control parameter is the processor control parameter 3302, the service name is “clothes sale”, the control parameter list is the control parameter list 2602, and the processor-addressed message body 1602 is “send message body 1700”. In the present embodiment, further, the processor control parameter and control parameter list are both null.

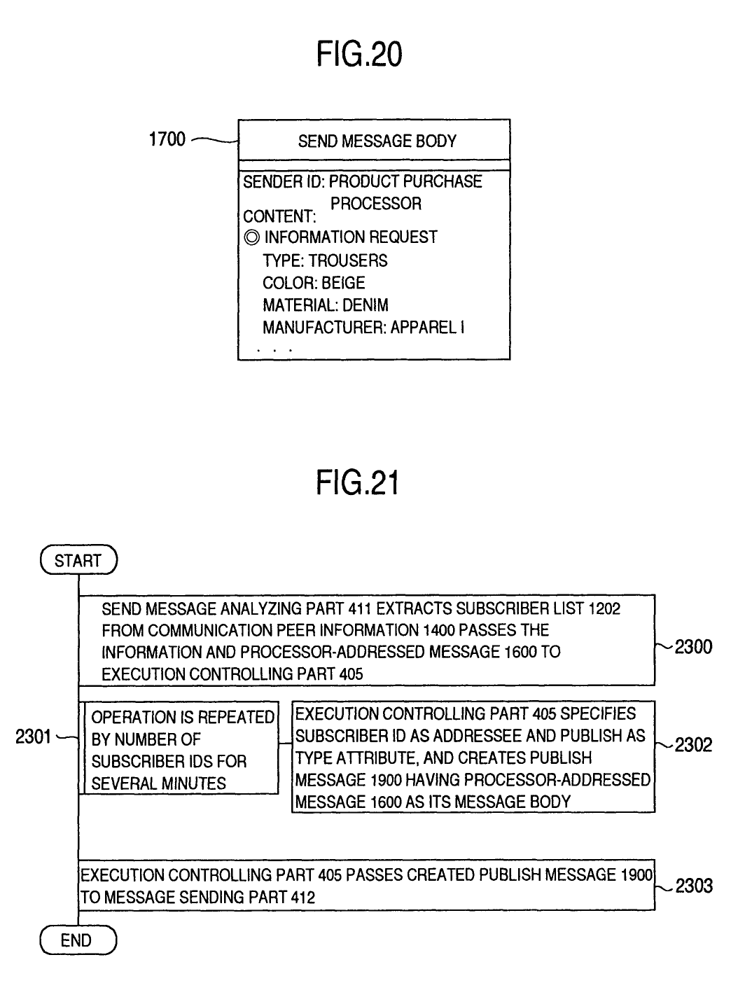

FIG. 20 shows a structure of the send message body in the present embodiment. FIG. 21 is a PAD showing a procedure of message-send-mode execution controlling operations in the present embodiment. With respect to the message-send-mode execution controlling operation of the step 705, the send message analyzing part 411 extracts at a step 2300 the subscriber list 1202 from the communication peer information 1400 and passes the extracted information and a processor-addressed message 1600 to the execution controlling part 405 as shown by the PAD of FIG. 21.

The operation is repeated at a next step 2301 by the number of subscriber IDs in the subscriber list to perform the operation of a step 2302. At the step 2302, the execution controlling part 405 creates a publish message 1900 having the subscriber ID designated as an addressee.

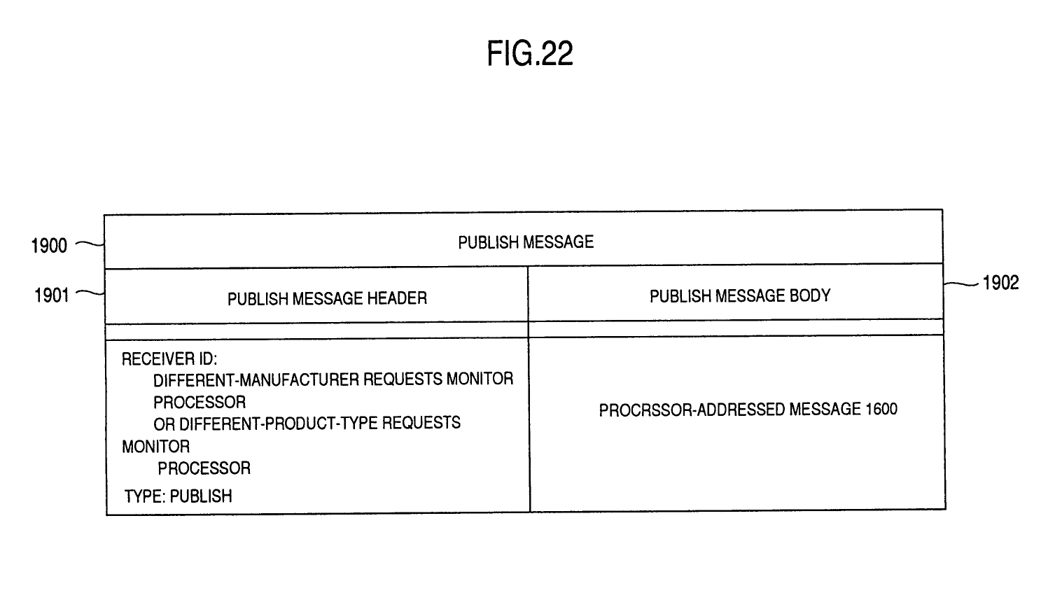

FIG. 22 shows a structure of the publish message in the present embodiment. In the present embodiment, since the subscriber ID includes two of “different-manufacturer-demands monitor processor” and “different-product-type-demands monitor processor”, two of the publish messages 1900 are created.

The two publish messages 1900 have each a publish message header 1901 and a publish message body 1902 (the processor-addressed message 1600 in the illustrated example); the header 1901 including a receiver ID (“different-manufacturer-demands monitor processor” or “different-product-type-demands monitor processor”) and a type attribute (‘publish’ in the illustrated example).

At a last step 2303, the execution controlling part 405 passes the created publish messages 1900 to the message sending part 412.

The message sending operation of the clothes sale processor 901 is basically the same as the common operation shown by the PAD of FIG. 8. The message receive mode execution controlling operation of the step 801 and the communication peer information storing operation of the step 803 are not carried out in the present embodiment.

In the present embodiment, in order to offer information to the product purchase processor 903, the message sending (returning) operation is required, so that the system proceeds from the step 806 to the step 807 to perform the message returning operation, which will be detailed now. The message returning operation of the clothes sale processor 901 is basically the same as the common operation shown by the PAD of FIG. 7.

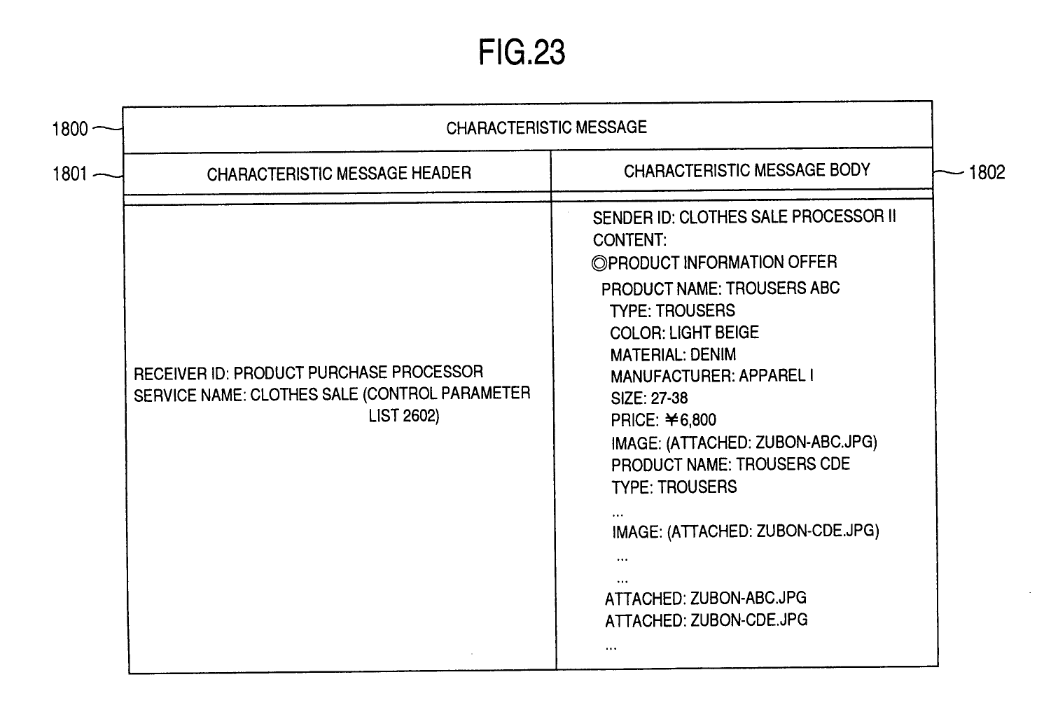

FIG. 23 shows a structure of the characteristic message in the present embodiment. The characteristic message created at the step 700 has such a structure as a characteristic message 1800 shown in FIG. 23.

The characteristic message 1800 is substantially the same as the characteristic message 1500, but different in that a characteristic message header 1801 of the message 1800 contains a pair of data of a service name of communication peer information as a key and a control parameter list as a value.

With respect to the values of the illustrated data, the receiver ID is “product purchase processor”, the service name is “clothes sale”, the control parameter list is “control parameter list 2602”, and a characteristic message body 1802 contains a plurality of pieces of product information matching the conditions required by the product purchase processor 903. Further, an image attribute in the product information shows a compressed image attached. In the present embodiment, further, the control parameter list is null.

The receiver ID is designated in the characteristic message 1800. Therefore, in the communication peer information acquiring operation of the step 701, the communication peer information is extracted from the communication peer information storage 404 at the step 2201 in the case of the foregoing embodiments. In the present embodiment, however, the communication peer information as a communication destination is not registered yet in the communication peer information storage 404, the characteristic message 1800 is used as it is, as a processor-addressed message at the step 704 and returned to the product purchase processor 903.

The message receiving operation of the different-manufacturer-demands monitoring device 904 is basically the same as the common operation shown by the PAD of FIG. 8. The message receive mode execution controlling operation of the step 801 and the communication peer information storing operation of the step 803 are not carried out in the present embodiment.

In the operation of the step 805, the different-manufacturer-demands monitoring device 904 recognizes that the message type attribute is ‘publish’ and processes a degree of interest in its product information as different-manufacturer in its product information as different-manufacturer statistical information. Since the message sending operation of the different-manufacturer-demands monitoring device 904 is unnecessary, it is judged at the step 806 that the message sending operation is unnecessary.

The message receiving operation of the different-type-products demand monitoring device 905 is basically the same as the common operation shown by the PAD of FIG. 8. The message receive mode execution controlling operation of the step 801 and the communication peer information storing operation of the step 803 are not carried out in the present embodiment.

The different-type-products demand monitoring device 905 in the operation of the step 805 recognizes that the message type attribute is ‘publish’ and processes a degree of interest in its product information as different-product-type statistical information. Since the message sending operation of the different-type-products demand monitoring device 905 is unnecessary, it is judged at the step 806 that the message sending operation is unnecessary.

As has been mentioned above, the communication managing part 110 of the product purchase processor 903 analyzes the searched result information received from the directory information manager 900 and sends its message to the different-manufacturer-demands monitoring device 904, different-type-products demand monitoring device 905 other than the clothes sale processor 901 or even to another monitor processor newly added, whereby the demand of the product purchase processor 903 can be grasped by the other monitor processor. Further, since a series of publish/subscribe operations are all carried out by the communication managing part 110, the need for an object-inherent operation developer of the product purchase processor 903 to develop it while taking the publish/subscribe into consideration can be eliminated and thus the developer can focus his or her energy on the response operation between a program for the object-inherent operation and the specific-clothes sale processor 901.

As has been mentioned above, according to the distributed system control method of the present embodiment, at the time of sending a message, directory information is acquired from the directory information manager and the message is sent based on the directory information, which results in that the communication peer, communication contents and execution method can be dynamically changed without changing the object and therefore the information processors in the distributed system can be centralizedly managed.

(Embodiment 3)

Explanation will be made as to a distributed system control method of an embodiment 3 for controlling operational modes of information processors in a distributed system on the basis of directory information of a directory information manager.

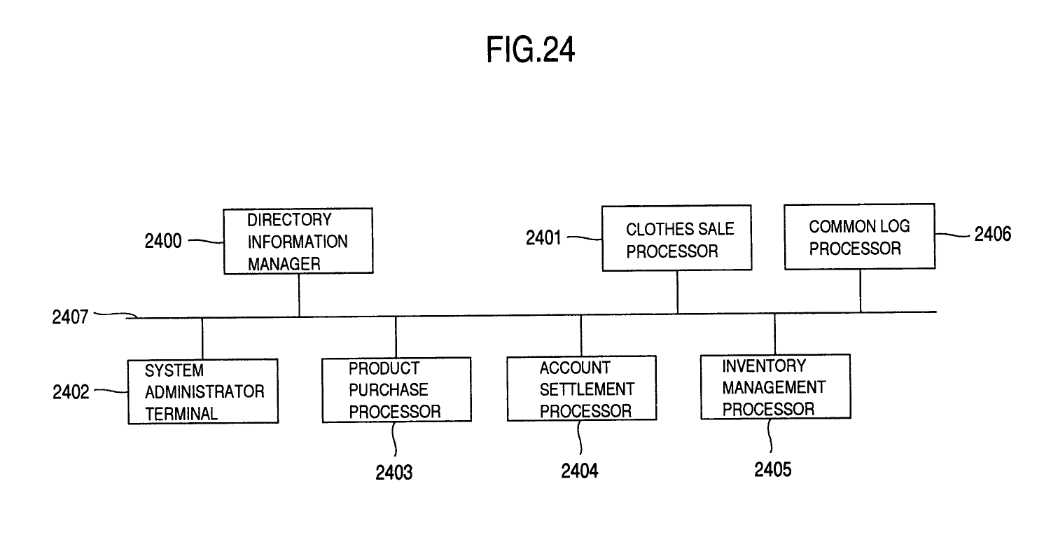

FIG. 24 schematically shows an arrangement of the distributed system of the present embodiment. In the present embodiment, a directory information manager 2400 manages information for general control of the entire operation of the distributed system to realize centralized management of the operation of the distributed system. As shown in FIG. 24, the distributed system of the present embodiment includes the directory information manager 2400, a clothes sale processor 2401, a system administrator terminal 2402, a product purchase processor 2403, an account settlement processor 2404, an inventory management processor 2405 and a network 2407. Connected to the network 2407 are the directory information manager 2400, clothes sale processor 2401, system administrator terminal 2402, product purchase processor 2403, account settlement processor 2404 and inventory management processor 2405.

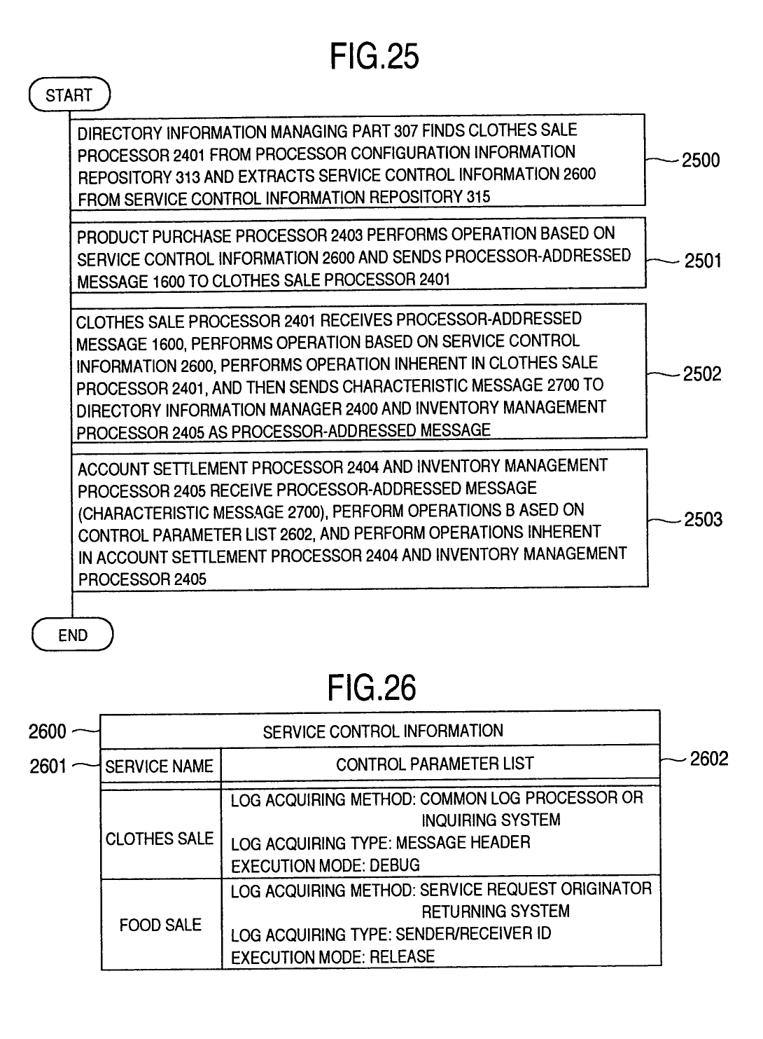

FIG. 25 is a PAD showing a procedure of distributed system controlling operations in the present embodiment. In the general operations of the present embodiment, after the directory information registering operations similar to those of the steps 200 and 201 in the PAD of FIG. 2 are carried out, the directory information managing part 307 finds the clothes sale processor 2401 having coincided searching conditions from the processor configuration information repository 313 and extracts service control information from the service control information repository 315 at a step 2500, as shown by the PAD in FIG. 25.

At a next step 2501, the product purchase processor 2403 performs its operation based on the service control information and sends the processor-addressed message 1600 to the clothes sale processor 2401.

At a next step 2502, the clothes sale processor 2401 receives the processor-addressed message 1600, performs its operation based on the service control information, performs operations inherent in the clothes sale processor 2401, and thereafter forwards a characteristic message 2700 to the account settlement processor 2404 and inventory management processor 2405 as a message addressed to the processors.

At a final step 2503, the account settlement processor 2404 and inventory management processor 2405 receive the processor-addressed message (characteristic message 2700), perform their operations based on the control parameter list 2602, and perform their operations inherent in the processors 2404 and 2405.

The operations of the product purchase processor 2403 from its acquisition of information on the clothes sale processor 2401 to its acquisition of product information from the clothes sale processor 2401 are substantially the same as the publish/subscribe operations. Accordingly explanation will be made as to the directory information registering operation of the clothes sale processor 2401, the purchase message sending operation of the product purchase processor 2403, the purchase message sending operation of the product purchase processor 2403, the message receiving operation of the clothes sale processor 2401, the purchase message forwarding operation of the clothes sale processor 2401, the message receiving operation of the account settlement processor 2404, and the message receiving operation of the inventory management processor 2405 as the service control operations.

The directory information registering operation of the clothes sale processor 2401 is basically the same as the common operation shown by the PAD of FIG. 5 to register the directory information including the service control information.

FIG. 26 shows a structure of the service control information in the present embodiment. The directory information at the step 500 includes processor configuration information 1100 and service control information 2600, and the service control information 2600 has such a structure as shown in FIG. 26.

An entry is a pair of data of a service name 2601 as a key and a control parameter list 2602 as a value. In the illustrated case, for example, with respect to the first entry, the service name 2601 is “clothes sale”, and the control parameter list 2602 is “log acquiring method: common log processor or inquiring system, log acquiring type: control parameter value is message header, execution mode: debug”. With respect to the second entry, the service name 2601 is “food sale”, and the control parameter list 2602 is “log acquiring method: service request originator returning system, log acquiring type: sender/receiver IDs, execution mode: release”.

Explanation will now be made as to the meaning of the control parameter list 2602 as an example. The ‘common log processor’ is a parameter which requests a log to be output to a common log processor 2406 when the log output is required. The ‘inquiring system’ is a parameter which demands of offering of a log previously held in each object when the administrator request the log offering. The ‘message header’ is a parameter which requests to take a message header in the message as a log. The ‘debug’ is a parameter which requests to execute the operation in such a condition that debuggable information can be always offered.

The ‘service request originator returning system’ is a parameter which requires the product purchase processor 2403 demanding offering of a service to return a log. The ‘sender/receiver IDs’ is a parameter which requires to take the sender/receiver IDs in the message as a log. The ‘release’ is a parameter which requires not to take debug information but to execute the operation with emphasis placed on performance.

The purchase message sending operations of the product purchase processor 2403 are basically the same as the common operation shown by the PAD of FIG. 7 and the publish/subscribe operations, and thus a forward message is first created as a characteristic message.

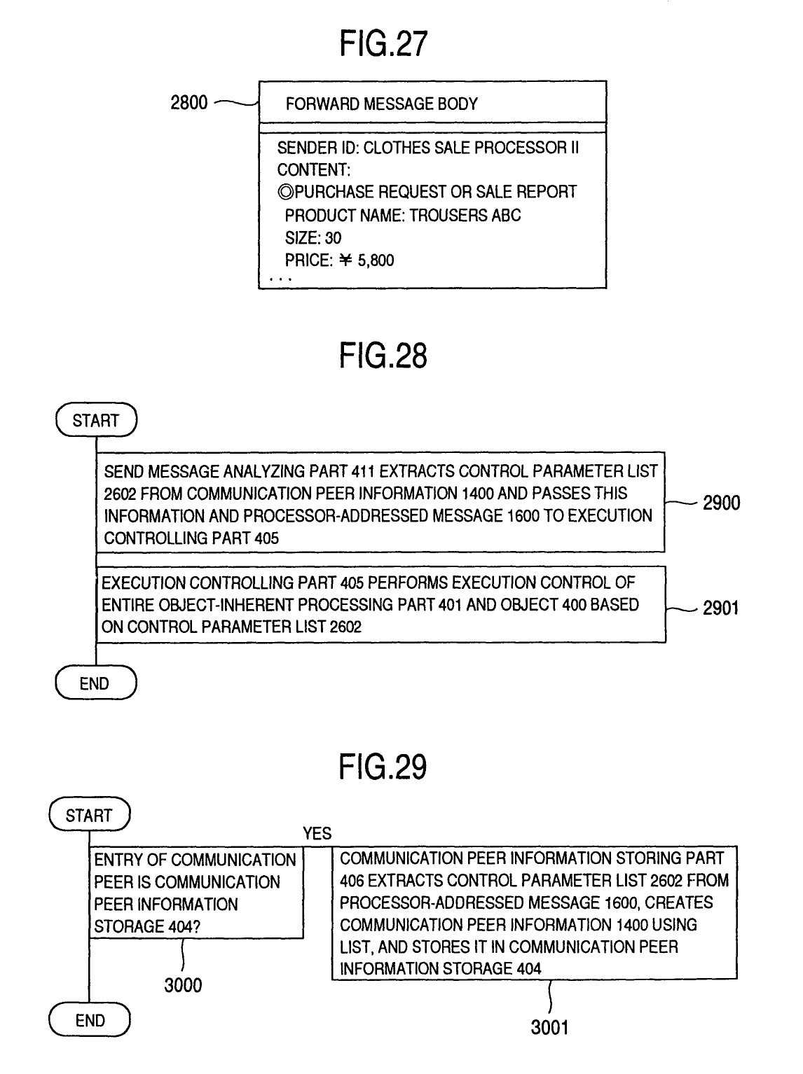

FIG. 27 shows a structure of the forward message in the present embodiment. In the characteristic message creating operation of the step 700, the characteristic message body at the step 2100 becomes a forward message body 2800 in FIG. 27 of the present embodiment, which has contents indicating to want to purchase a product having a specified trade name and size.

At the next step 2200 corresponding to the communication peer information acquiring operation of the step 701, since a receiver ID is present in the present embodiment, the operation of the step 2201 is carried out. The processor-addressed message at the step 704 has such a structure as shown in FIG. 19. In this conjunction, the present embodiment is assumed that the receiver ID in the processor-addressed message header 1601 is “account settlement processor I” as the ID of the account settlement processor 2404, the processor control parameter is null, and the processor-addressed message body 1602 is “forward message body 2800”.

FIG. 28 is a PAD showing a procedure of message-send-mode execution controlling operations in the present embodiment. In the message-send-mode execution controlling operation of the step 705, the send message analyzing part 411 extracts the control parameter list 2602 from the communication peer information 1400 and passes the extracted information and the processor-addressed message 1600 to the execution controlling part 405 at a step 2900, as shown by the PAD of FIG. 28.

At a next 2901, the execution controlling part 405 outputs the message header of the processor-addressed message 1600 to the common log processor 2406 on the basis of the control parameter list 2602 to change the execution mode of the processor 2403 and to put the product purchase processor 2403 in its debug mode.

The purchase message receiving operation of the clothes sale processor 2401 is basically the same as the common operation shown by the PAD of FIG. 8. In the message receive mode execution controlling operation of the step 801, as in the message-send-mode execution controlling operation of the purchase message sending operation of the product purchase processor 2403 of FIG. 28, the message header of the processor-addressed message 1600 is output to the common log processor 2406 to change the execution mode of the clothes sale processor 2401 to its debug mode.

FIG. 29 is a PAD showing a procedure of communication peer information storing operations in the present embodiment. With respect to the communication peer information storing operation of the step 803, as shown by the PAD of FIG. 29, it is judged at a step 3000 whether or not the entry of the product purchase processor 2403 is present in the communication peer information storage 404.

If the entry of the product purchase processor 2403 is absent in the communication peer information storage 404, then the communication peer information storing part 406 extracts the subscriber ID (product purchase processor in this case), service name and control parameter list 2602 from the processor-addressed message 1600 at a step 3001 to create the communication peer information 1400, and stores the created information in the communication peer information storage 404. When the entry of the product purchase processor 2403 is already stored in the previous information request message receiving operation, the storing operation is not carried out this time.

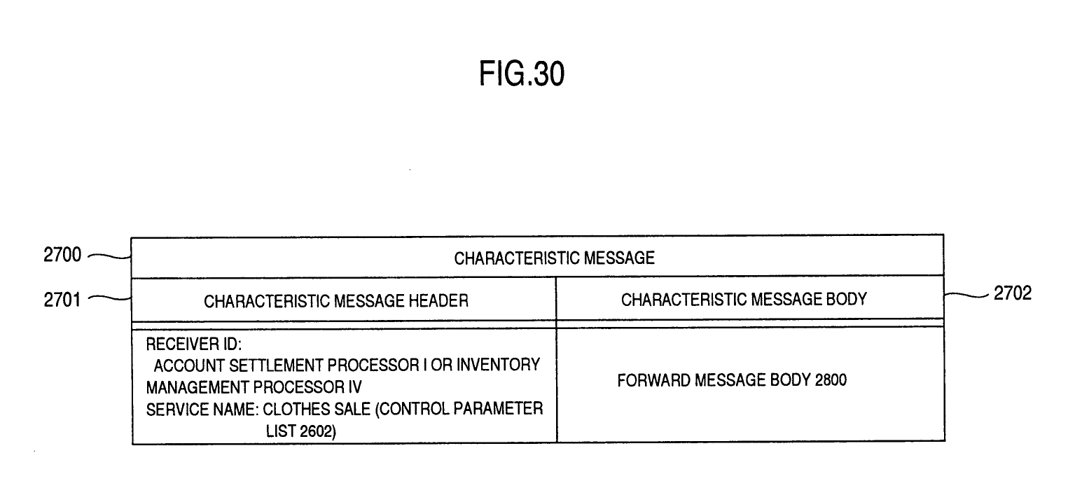

FIG. 30 shows a structure of the characteristic message in the present embodiment. With respect to the operation of the step 805, the object-inherent processing part 401 creates a message addressed to the account settlement processor 2404 and a message addressed to the inventory management processor 2405 such as the characteristic message 2700 shown in FIG. 30 in order to conduct a product purchase procedure. These messages will be later explained in the description of the message forwarding operation of the clothes sale processor 2401.

In the present embodiment, since the information is provided to the inventory management processor 2405 and account settlement processor 2404, the message sending (forwarding) operation is necessary. Accordingly the system proceeds from the step 806 to the step 807 to perform the message forwarding operation, which will be explained below.

The message forwarding operation of the clothes sale processor 2401 is basically the same as the common operation shown by the PAD of FIG. 7. The characteristic message created at the step 700 has such a structure as the characteristic message 2700 of FIG. 30.

In this case, as the communication peer information, the receiver ID of a characteristic message header 2701 is “account settlement processor I” as the ID of the account settlement processor 2404 or “inventory management processor IV” as the ID of the inventory management processor 2405; the service name is “clothes sale”, the control parameter list is the control parameter list 2602, and a characteristic message body 2702 has such a forward message body 2800 as shown in FIG. 27.

In this example, the control parameter list 2602 is handed over from the processor-addressed message 1600 of the product purchase processor 2403 to the clothes sale processor 2401. The forward message body 2800 has a content indicative of a sales report of a product name, size and price, written therein.

In the communication peer information acquiring operation of the step 701, since the receiver ID is specified in the characteristic message 2700, the communication peer information 1400 is extracted from the communication peer information storage 404 at the step 2201. In the present embodiment, however, the communication peer information 1400 obtained therein is null. Accordingly the characteristic message 2700 is used as it its, as the processor-addressed message at the step 704, and forwarded to the account settlement processor 2404 and inventory management processor 2405.

The message receiving operation of the account settlement processor 2404 is basically the same as the common operation shown by the PAD of FIG. 8. In the message receive mode execution controlling operation of the step 801, as in the message-send-mode execution controlling operation in the purchase message sending operation of the product purchase processor 2403 of FIG. 28, the processor-addressed message is used as the characteristic message 2700 and the message header of the message is output to the common log processor 2406 to change the execution mode of the account settlement processor 2404 to its debug mode.

The communication peer information storing operation of the step 803, assuming that the sender is the clothes sale processor 2401, is substantially the same as the communication peer information storing operation in the purchase message receiving operation of the clothes sale processor 2401.

In the operation of the step 805, the object-inherent processing part 401 of the account settlement processor 2404 debits the bank account of the product purchase processor 2403 for the specified amount of ¥5,800. Since the message sending operation of the step 806 is unnecessary, it is judged that the message sending operation is unnecessary at the step 806.

The message receiving operation of the inventory management processor 2405 is basically the same as the message receiving operation of the account settlement processor 2404. In the operation of the step 805, the object-inherent processing part 401 of the inventory management processor 2405 examines the presence or absence of a product having the specified size in stock, and if necessary, orders it to the manufacturer and performs such operation as to cause the product purchase processor 2403 to deliver the product.

As mentioned above, since the directory information manager 2400 centralizedly manages information about control of the operation of the distributed system as the directory information, the operation of the distributed system can be easily changed all together by changing the directory information. Further, since the operation specified by the directory information manager 2400 is carried out by the communication managing part 110 of each information processor, it can be made unnecessary to change the objects of the existing information processors and the need for rebooting the information processors can be eliminated. In particular, the product purchase processor 2403 can eliminate the need to intentionally have the service information processor now in communication with in mind and can perform the specified operation.

As has been explained above, according to the distributed system control method of the present embodiment, when it is desired to send a message, the directory information is acquired from the directory information manager and message transmission is carried out on the basis of the directory information. As a result, the communication peer, communication contents and execution method can be dynamically changed without modifying the object and the information processors in the distributed system can be centralizedly managed.

(Embodiment 4)

Explanation will next be made as to a distributed system control method of an embodiment 4 for converting the format of a message forwarded from a clothes sale processor to a account settlement processor into a format requested by the account settlement processor on the basis of directory information of a directory information manager.

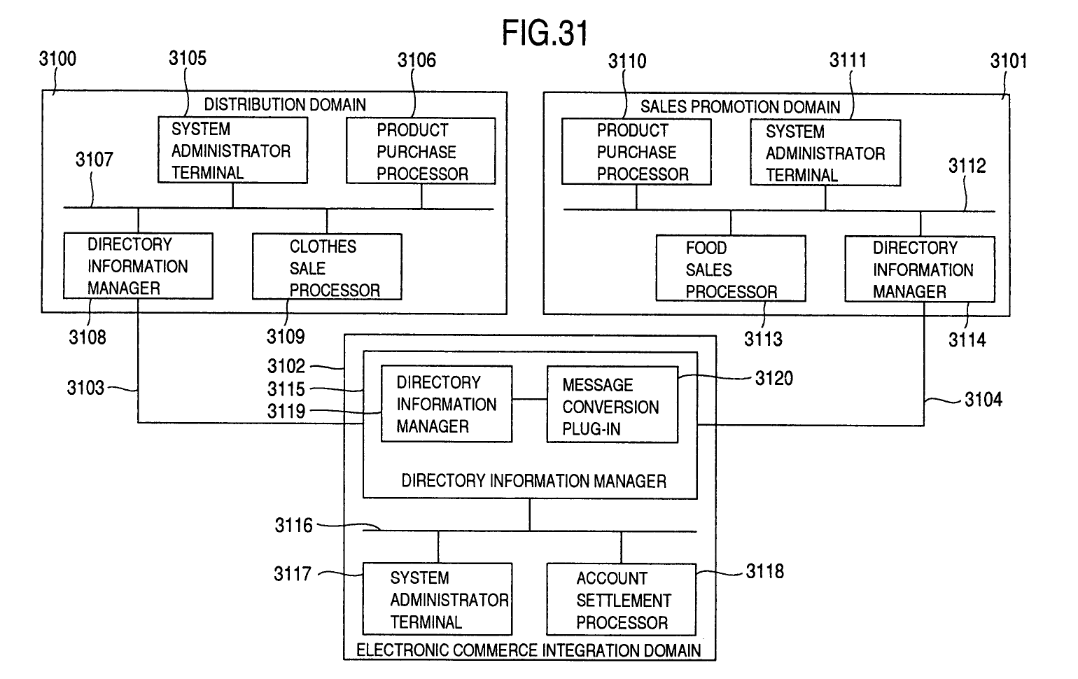

FIG. 31 schematically shows an arrangement of a distributed system of the present embodiment. As shown in FIG. 31, the distributed system of the present embodiment includes a distribution domain 3100, a sales promotion domain 3101, an electronic commerce integration domain 3102, a network 3103 and another network 3104. The distribution domain 3100 and electronic commerce integration domain 3102 are connected to the network 3103, while the sales promotion domain 3101 and electronic commerce integration domain 3102 are connected to the network 3104.

The distribution domain 3100 has a system administrator terminal 3105, a product purchase processor 3106, a network 3107, a directory information manager 3108 and a clothes sale processor 3109. Connected to the network 3107 are the system administrator terminal 3105, product purchase processor 3106, directory information manager 3108 and clothes sale processor 3109.

The sales promotion domain 3101 has a product purchase processor 3110, a system administrator terminal 3111, a network 3112, a food sales processor 3113 and a directory information manager 3114. Connected to the network 3112 are the product purchase processor 3110, system administrator terminal 3111, food sales processor 3113 and directory information manager 3114.

The electronic commerce integration domain 3102 has a directory information manager 3115, a network 3116, a system administrator terminal 3117 and an account settlement processor 3118. Connected to the network 3116 are the directory information manager 3115, system administrator terminal 3117 and account settlement processor 3118. The directory information manager 3115 has, in addition to the processing parts shown in FIG. 3, a message conversion plug-in 3120.

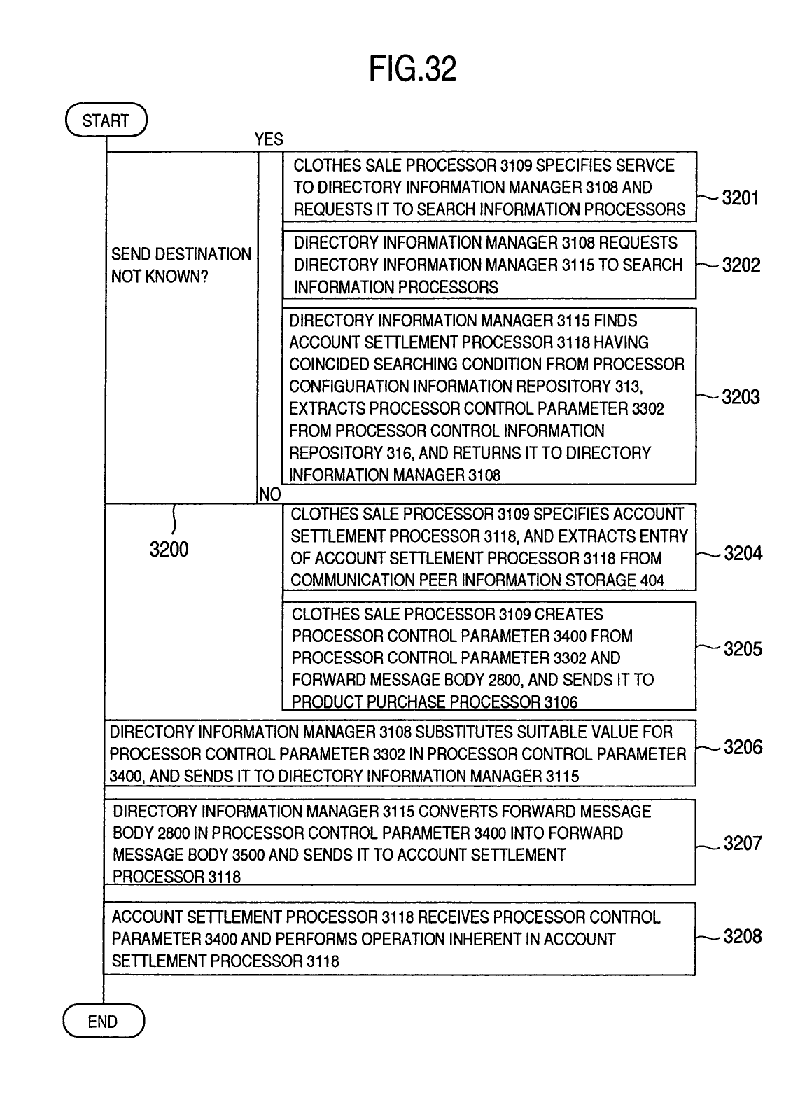

FIG. 32 is a PAD showing a procedure of the distributed system controlling operations in the present embodiment. In the general operations of the present embodiment, directory information registering operation similar to that shown by the PAD of FIG. 2 is carried out, after which it is judged at a step 3200 whether or not the send destination of the message is known as shown by the PAD of FIG. 32.

When the message send destination is unknown, the system performs the operations of steps 3201 to 3203. At the step 3201, the clothes sale processor 3109 requests the directory information manager 3108 to specify the service and search its information processor. At the next step 3202, the directory information manager 3108 requests the directory information manager 3115 to search the information processor. At the next step 3203, the directory information manager 3115 finds the account settlement processor 3118 having coincided searching conditions from the processor configuration information repository 313, extracts the processor control parameter 3302 from the processor control information repository 316, and returns it to the directory information manager 3108.

When the message send destination is known, on the other hand, the system carries out the operations of steps 3204 and 3205. At the step 3204, the clothes sale processor 3109 specifies the account settlement processor 3118 and extracts the communication peer information 1400 from the communication peer information storage 404. At the next step 3205, the clothes sale processor 3109 creates a processor control parameter 3400 on the basis of the processor control parameter 3302 and forward message body 2800, and sends the created message to the directory information manager 3108.

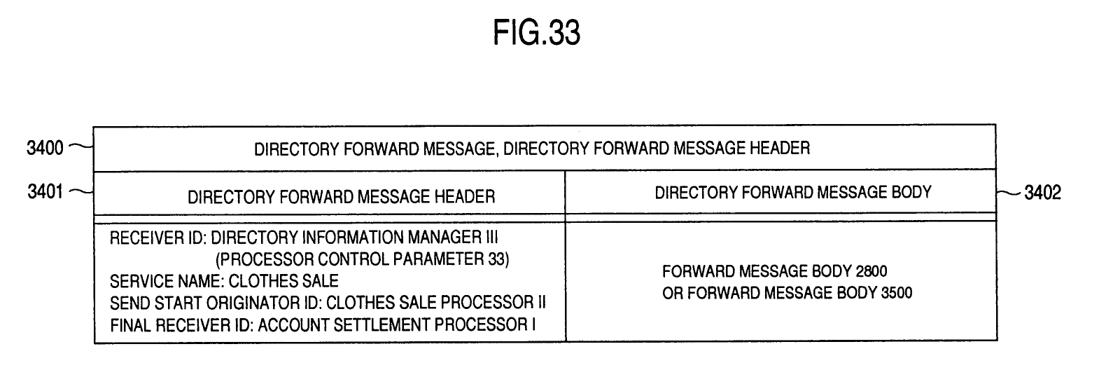

FIG. 33 shows a structure of the forward message in the present embodiment. At a next step 3206, the directory information manager 3108 substitutes a suitable value for the processor control parameter 3302 in the processor control parameter 3400 and sends the message to the directory information manager 3115.

At a next step 3207, the directory information manager 3115 converts the forward message body 2800 in the processor control parameter 3400 into a forward message body 3500 and sends it to the account settlement processor 3118.

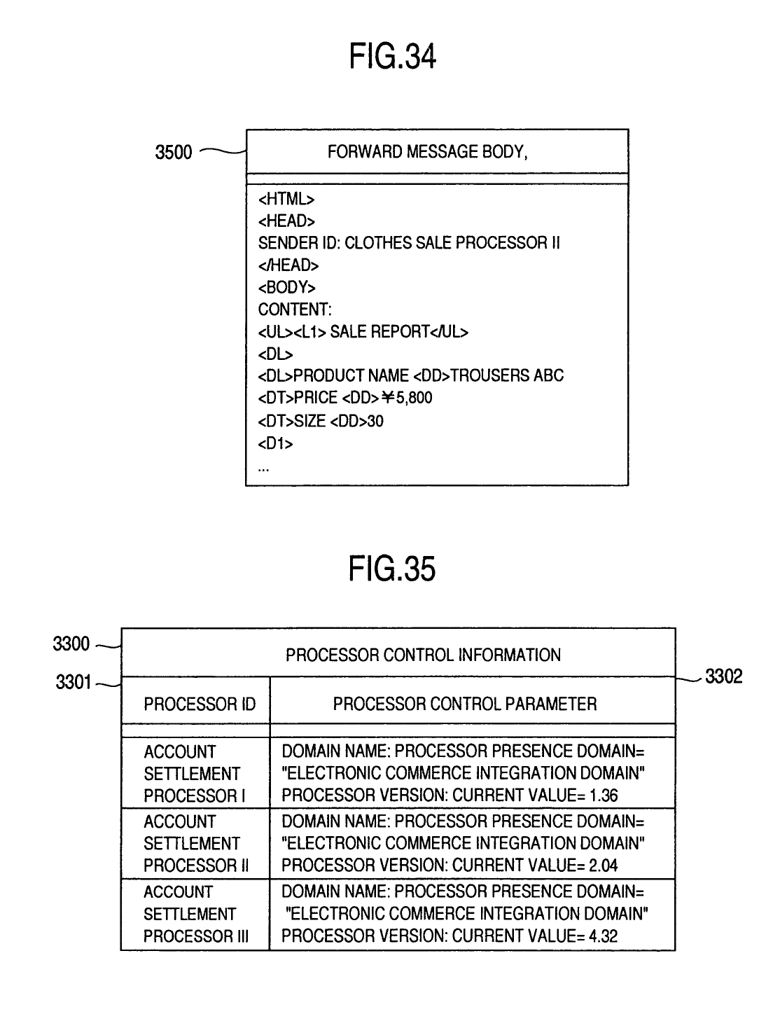

FIG. 34 shows a structure of the forward message body in the present embodiment. At a step 3208, finally, the account settlement processor 3118 receives the processor control parameter 3400 to perform the operation inherent in the account settlement processor 3118.

The communication within the distribution domain 3100 and the communication within the sales promotion domain 3101 are substantially the same as the publish/subscribe operations. Further, the communicating operation between the distribution domain 3100 and electronic commerce integration domain 3102 is substantially the same as the communicating operation between the sales promotion domain 3101 and electronic commerce integration domain 3102.

Accordingly as the control operations of the information processor, the directory information registering operation of the account settlement processor 3118, the communication peer information acquiring operation of the clothes sale processor 3109, the message forwarding operation of the clothes sale processor 3109, the message forwarding operation of the directory information manager 3108 and directory information manager 3115, and the message receiving operation of the account settlement processor 3118 will be explained.

The directory information registering operation of the account settlement processor 3118 is basically the same as the common operation shown by the PAD of FIG. 5.

FIG. 35 shows a structure of the processor configuration information in the present embodiment. The directory information at the step 500 includes the processor configuration information 1100 and processor configuration information 3300, and has such a structure as shown in FIG. 35.

An entry is a pair of data of a processor ID 3301 as a key and a processor control parameter 3302 as a value. In the illustrated example, for instance, with respect to the first entry, the processor ID 3301 is “account settlement processor I” as the ID of the account settlement processor 3118, and the processor control parameter 3302 is “domain name: processor presence domain=electronic commerce integration domain, processor version: current value=1.36”. With respect to the second entry, the processor ID 3301 is “account settlement processor II”, and the processor control parameter 3302 is “domain name: processor presence domain=electronic commerce integration domain, processor version: current value=2.04”. With respect to the third entry, the processor ID 3301 is “account settlement processor III”, and the processor control parameter 3302 is “domain name: processor presence domain=electronic commerce integration domain, processor version: current value=4.32”.

The meaning of contents of the processor control parameter 3302 will be explained in connection with the first entry as an example. The ‘domain name: sender presence domain=electronic commerce integration domain’ is a parameter which, at the time of sending a message to the account settlement processor 3118, requests to attach thereto a domain name to which the sender belongs; and the domain name “electronic commerce integration domain” to which the account settlement processor 3118 belongs, has a default value. The ‘processor version: current value=1.36’ is a parameter which requests the sender to attach a version to the account settlement processor 3118 with which the sender is to communicate, and the current account settlement processor 3118 has a default value of 1.36 as its version.

The communication peer information acquiring operation of the clothes sale processor 3109 is basically the same as the common operation shown by the PAD of FIG. 6 and the publish/subscribe operation. In the present embodiment, the system accepts not the searching condition 1300 but the entire object-inherent message including the searching condition 1300 as its input, and perform operations which follow.

The clothes sale processor 3109 first requests the directory information manager 3108 to acquire the communication peer information 1400. However, since the information processor having the searching condition 1300 coincided therewith is not present in the distribution domain 3100, the communication peer information 1400 is not obtained at the steps 600 to 602.

At the next step 605, the directory information manager 3108 requests the directory information manager 3115 to perform searching operation. In the communication peer information acquiring operation of the directory information manager 3115, the communication peer information obtained at the step 602 has such a structure as shown in FIG. 15. The communication peer information 1400 obtained in the present embodiment includes the processor ID 1401 and processor control parameter 1402 among the aforementioned information. In this example, the processor ID 1401 is “account settlement processor I” as the ID of the account settlement processor 3118, and the processor control parameter 1402 is first one of the processor control parameters 3302.

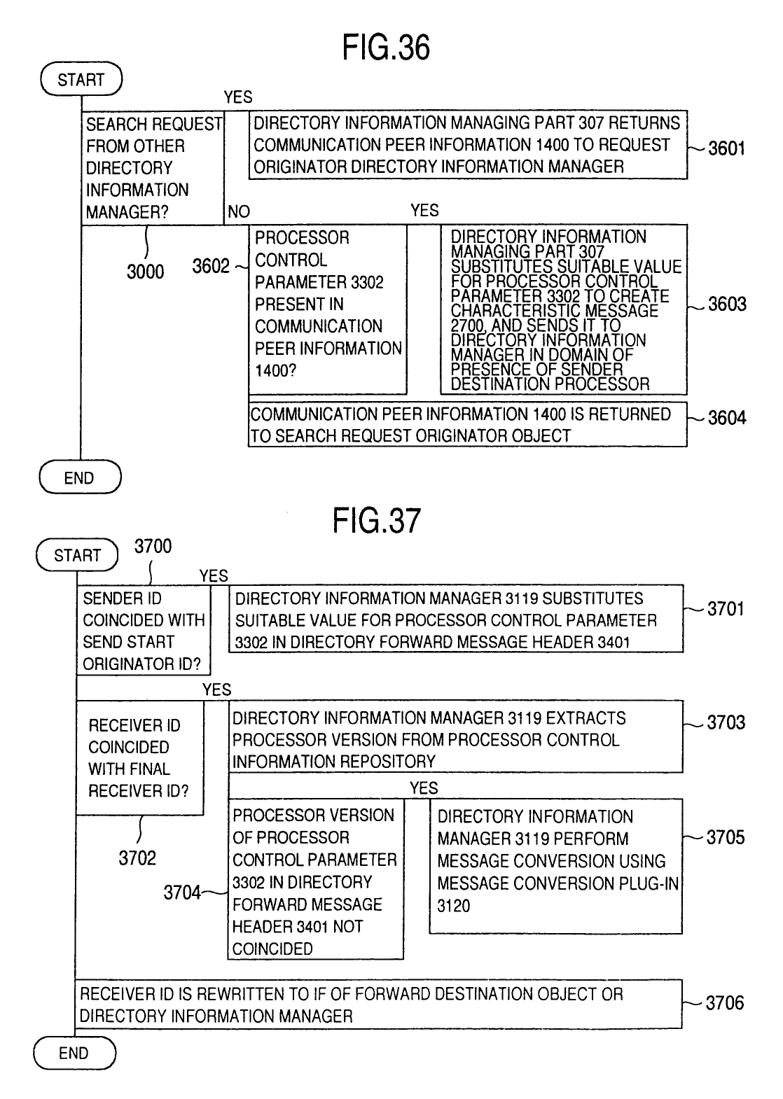

FIG. 36 is a PAD showing change points in the communication peer information acquiring operation of the present embodiment. The operations of the directory information managers 3115 and 3108 at the steps 608 to 610 are carried out as shown in the PAD of FIG. 36.

At a step 3600, the directory information manager 3115 judges whether or not the processing request is from another directory information manager. In this example, since the processing request is from the directory information manager 3108, the system proceeds to a step 3601 and returns the above acquired communication peer information 1400 to the directory information manager 3108.

The directory information manager 3108 when receiving the communication peer information 1400, similarly judges at the step 3600 whether or not the processing request is from another directory information manager. In this example, since the processing request is from the clothes sale processor 3109, that is, not from another directory information manager, the directory information manager judges at a step 3603 whether or not the processor control parameter 3302 is included in the communication peer information 1400.

In this case, since the processor control parameter 3302 is included in the communication peer information 1400, at the step 3603, the directory information managing part 307 substitutes a suitable value for the processor control parameter 3302, creates the processor control parameter 3400, and sends it to the directory information manager 3115 of the domain in which the sender information processor is present. In this embodiment, the “suitable value” refers to the domain name of “distribution domain” and the processor version of “1.36” (defaults are used as they are because this is the first communication with the account settlement processor 3118).

The processor control parameter 3400 has such a structure as shown in FIG. 33, in which case a send start originator is the ID of the object which sent first the message and a last receiver ID is the ID of the object which finally receives the message.

In the present embodiment, with respect to a directory forward message header 3401, the receiver ID is “directory information manager III” as the ID of the directory information manager 3115, the processor control parameter is the processor control parameter 3302, the send start originator ID is “clothes sale processor II” as the ID of the clothes sale processor 3109, the last receiver ID is “account settlement processor I” as the ID of the account settlement processor 3118. A directory forward message body 3402 is the forward message body 2800 or forward message body 3500. At a step 3604, finally, the system returns the communication peer information 1400 to the clothes sale processor 3109 as the request originator object.

The message forwarding operation of the clothes sale processor 3109 is basically the same as the common operation shown by the PAD of FIG. 7 and as the message forwarding operation of the clothes sale processor 2401 in the service control.

If the receiver ID (“account settlement processor I” as the ID of the account settlement processor 3118 in this embodiment) is unknown at the step 2200, then a message is sent from the directory information manager 3108 to the account settlement processor 3118 through the communication peer information acquiring operation of the clothes sale processor 3109. Therefore the clothes sale processor 3109 stores the communication peer information 1400 returned from the directory information manager 3108 in the communication peer information storage 404 and performs its execution controlling operation based on the communication peer information 1400, thus terminating the operation.

If the receiver ID is known, on the other hand, then the clothes sale processor 3109 extracts the communication peer information 1400, creates a processor-addressed message (the processor control parameter 3400 having the directory information manager 3108 as the receiver ID), sends the message to the directory information manager 3108, and performs its execution controlling operation based on the communication peer information 1400, thus terminating the operation.

The communication peer information 1400 contains the processor control parameters 3302 in which the domain name is null and the processor version is “1.36” obtained through the previous searching operation. The processor version value “1.36” held in the communication peer information storage 404 by the clothes sale processor 3109 indicates that it is unnecessary to change the mounting of the clothes sale processor 3109, so long as the clothes sale processor 3109 communicates with the information processor having this version.

FIG. 37 is a PAD showing a procedure of message forwarding operations in the present embodiment. In the message forwarding operation of the directory information manager 3108 and directory information manager 3115, as shown by the PAD of FIG. 37, it is judged at a step 3700 whether or not the subscriber ID coincides with the send start originator ID. If the subscriber ID coincides with the send start originator ID, then data (a domain name of “distribution domain” in the present embodiment) to be substituted for the processor control parameter 3302 in the directory forward message header 3401 is substituted therefor at a step 3701.

It is judged at a next 3702 whether or not the receiver ID coincides with the last receiver ID. A coincidence between the receiver ID and last receiver ID causes a directory information manager 3119 to extract the version of the current information processor from the processor control information repository 316 at a step 3703. When the information processor is already upgraded (version-up), as when the version of the information processor is upgraded to “4.92”; the directory information manager 3119 extracts the new version and judges whether or not the version of the current information processor coincides with the version (“1.36”) of the information processor in the processor control parameter 3302 of the directory forward message header 3401.

When finding a non-coincidence between the information processor versions, the directory information manager 3119 at a step 3704 performs message conversion with use of the message conversion plug-in 3120. In the present embodiment, the forward message body 2800 of the FIG. 27 is converted into such an HTML format as shown by the forward message body 3500 of FIG. 34.

At a step 3706, finally, the directory information manager 3119 rewrites the receiver ID of the processor control parameter 3400 into a next send destination (“directory information manager III as the ID of the directory information manager 3115” in the case of the directory information manager 3108, while “account settlement processor I” as the ID of the account settlement processor 3118 in the case of the directory information manager 3115) of the receiver ID, and then the written message is sent.

The message receiving operation of the account settlement processor 3118 is substantially the same as the message receiving operation of the account settlement processor 2404 in the service control. In the operation of the step 805, the object-inherent processing part 401 of the account settlement processor 3118 recognizes that the product purchase processor 3106 is the object of the distribution domain 3100, coverts, e.g., the specified amount “¥5,800” to a US dollar equivalent, and performs such operation inherent in the account settlement processor 3118 as to withdraw it from the bank A.

Although the message conversion has been carried out through the directory information manager in the present embodiment, it is also possible to employ such a method that the clothes sale processor 3109 directly sends the message to the account settlement processor 3118 and the account settlement processor 3118 requests the message conversion plug-in 3120 to perform the message conversion via the electronic commerce integration domain 3102 to which the account settlement processor 3118 itself also belongs.

As has been explained above, since the directory information manager manages and processes information requested in the message to the information processor, the information processor as the send originator can send the message without paying attention to the information requested by the information processor as the send destination. Further, in addition of the message sending/receiving operations, the information processor can prevent generation of such a traffic as to request message processing. Furthermore, when there are possibly a plurality of information processors which execute the same kind of services, the message conversion corresponding to the individual information processors can be carried out without the need for changing the object of the information processor as the send originator. For this reason, the present invention can cope with the specification change or upgrade of the information processor.

As has been explained above, in accordance with the distributed system control method of the present embodiment, at the time of sending a message, the directory information is acquired from the directory information manager and the message transmission is carried out on the basis of the directory information, the change of the communication peer, communication contents and execution method can be dynamically carried out without the need for changing the object and thus the information processors in the distributed system can be centralizedly managed.

(Embodiment 5)

Explanation will next be made as to a distributed system control method of an embodiment 5 for changing the clothes sale processor with which the product purchase processor is to communicate, on the basis of the directory information of the directory information manager.

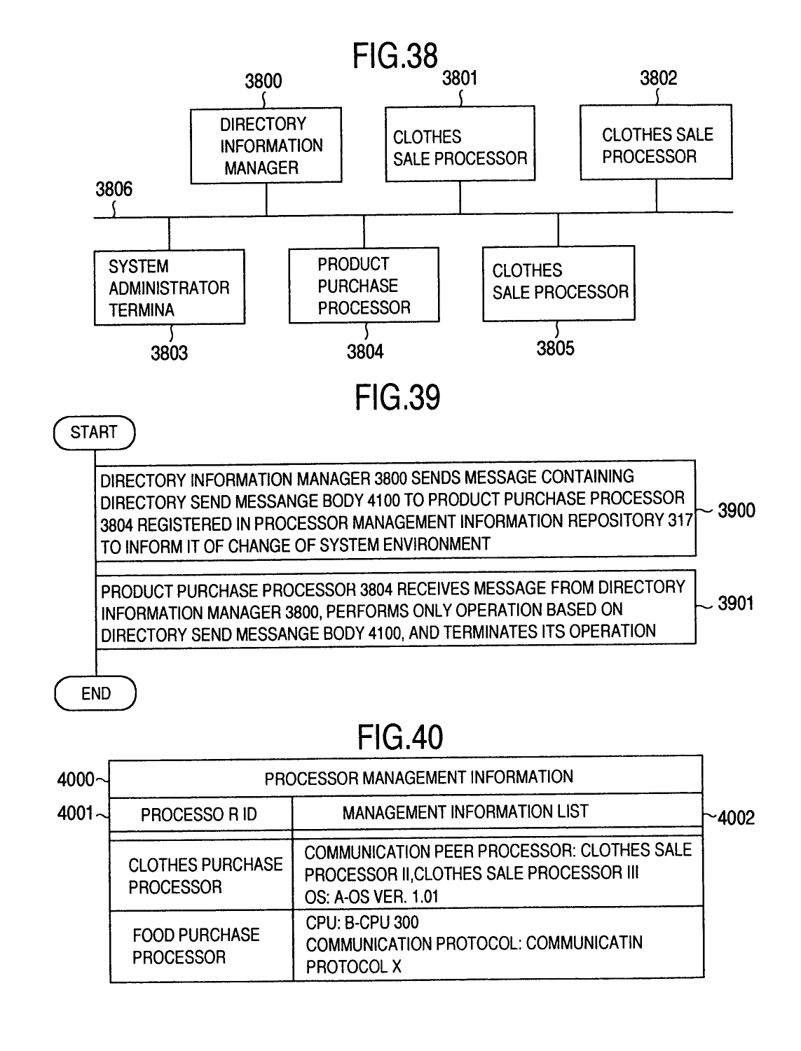

FIG. 38 schematically shows an arrangement of the distributed system of the present embodiment. As shown in FIG. 38, the distributed system of the present embodiment includes a directory information manager 3800, a clothes sale processor 3801, a clothes sale processor 3802, a system administrator terminal 3803, a product purchase processor 3804, a clothes sale processor 3805, and a network 3806. Connected to the network 3806 are the directory information manager 3800, clothes sale processor 3801, clothes sale processor 3802 system administrator terminal 3803, product purchase processor 3804 and clothes sale processor 3805.

FIG. 39 is a PAD showing a procedure of distributed system controlling operation of the present embodiment. In the general operation of the present embodiment, after substantially the same directory information registering operations of the steps 200 and 201 in the PAD of FIG. 2, the directory information manager 3800 sends a message containing a directory send message body 4100 at a step 3900 to the product purchase processor 3804 registered in the processor management information repository 317 to inform the product purchase processor 3804 of a change in the system environment, as shown by the PAD of FIG. 39.

At a step 3901, finally, the product purchase processor 3804 receives the message from the directory information manager 3800, and performs operation based on the directory send message body 4100, thus terminating the operation.

Explanation will then be made as to the directory information registering operation of the product purchase processor 3804 and as to the message receiving operation of the product purchase processor 3804. The directory information registering operation of the product purchase processor 3804 is basically the same as the common operation shown by the PAD of FIG. 5.

FIG. 40 shows a structure of the processor management information in the present embodiment. The directory information of the step 500 corresponds to the processor configuration information 1100 and processor management information 4000, and the information 4000 has such a structure as shown in FIG. 40.

In this case, an entry is a pair of data of a processor ID 4001 as a key and a management information list 4002 as a value. For example, with respect to the first entry, the processor ID 4001 is “clothes purchase processor”, and the management information list 4002 is “communication peer: clothes sale processor II, clothes sale processor III, OS: A-OS Ver. 1.01”. With respect to the second entry, the processor ID 4001 is “food purchase processor”, and the management information list 4002 is “CPU: B-CPU 300, communication protocol: Communication Protocol X”. In this conjunction, the “clothes sale processor II” is the ID of the clothes sale processor 3805 and the “clothes sale processor III” is the ID of the clothes sale processor 3801.

The message receiving operation of the product purchase processor 3804 is basically the same as the common operation shown by the PAD of FIG. 8.

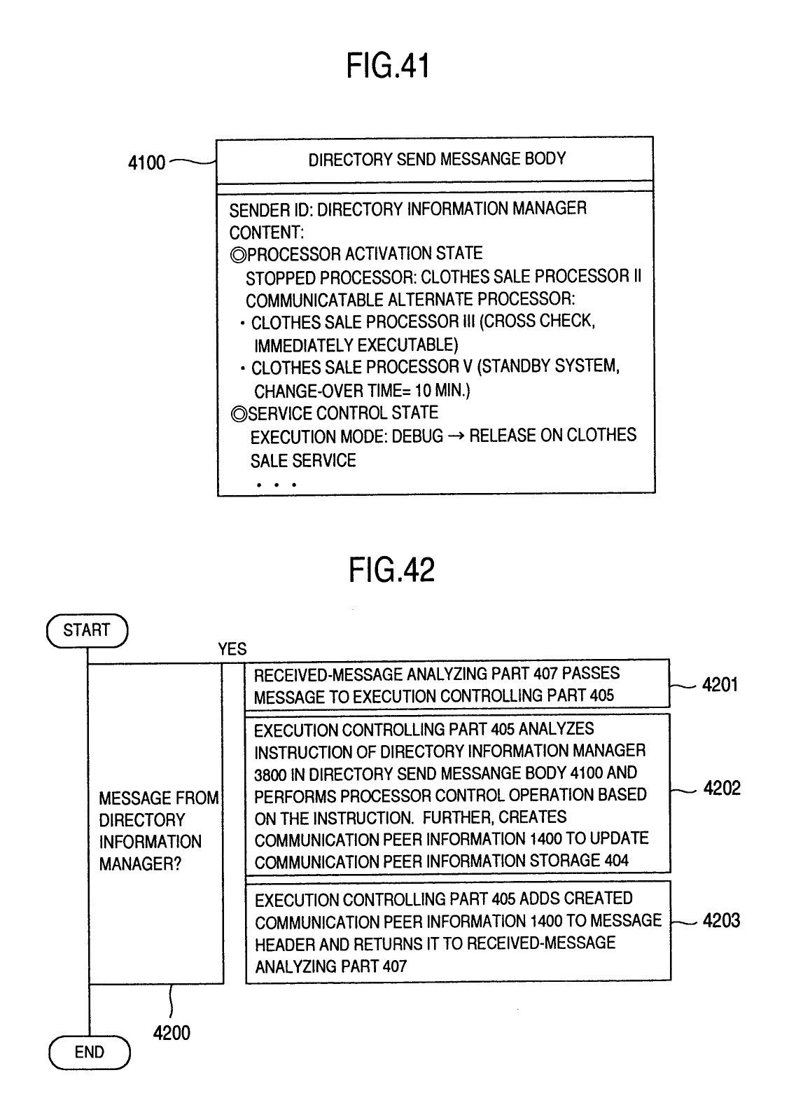

FIG. 41 shows a structure of the directory send message body in the present embodiment. The object-inherent message body of the message received by the product purchase processor 3804 at the step 800 corresponds to the directory send message body 4100 shown in FIG. 41. The directory send message body 4100 has a content that a sender ID as a header is “directory information manager”, and that a content as a header is to request to use “clothes sale processor III” (cross check, immediately executable) and “clothes sale processor V” (standby system, change-over time=10 min.) as alternate communicatable processors and also to request to change the clothes sale service execution control mode from debug to release, because “clothes sale processor II” (clothes sale processor 3805) in the boot mode has been stopped.

Explanation will now be made as to the “clothes sale processor III” (clothes sale processor 3801) and “clothes sale processor V” (clothes sale processor 3802) specified as the alternate processors. The above means that the clothes sale processor 3801 has a cross-check relationship of their operations with the clothes sale processor 3805 and is always operated, so that the clothes sale processor 3801 can be immediately used in place of the clothes sale processor 3805 without any change-over time. Further, the above means that, since the clothes sale processor 3802 has a mutual load distribution relationship with the clothes sale processor 3805, the stopped clothes sale processor 3805 is replaced with the clothes sale processor 3802 with a change-over time of 10 minutes, after which the clothes sale processor 3802 can be used.

FIG. 42 is a PAD showing a procedure of message receive mode execution controlling operation in the present embodiment. With respect to the message receive mode execution controlling operation of the step 801, it is judged at a step 4200 whether or not the received message was sent from the directory information manager 3800, as shown by the PAD of FIG. 42.

If the received message was sent from the directory information manager 3800, then the received-message analyzing part 407 passes the message as it is to the execution controlling part 405 at a step 4201.

At a next step 4202, the execution controlling part 405 analyzes the instruction of the directory information manager 3800 specified in the directory send message body 4100. The execution controlling part 405, on the basis of the analyzed result, changes the communication peer to the immediately-communicatable clothes sale processor 3801 and changes the execution mode to the release mode. And in order to change the communication peer information storage 404, the execution controlling part 405 creates an entry of the service control information from the service execution state information in the directory send message body 4100 and creates the communication peer information 1400 using the entry.

At a step 4203, finally, the execution controlling part 405 attaches the created communication peer information 1400 to the received message and returns it to the received-message analyzing part 407.

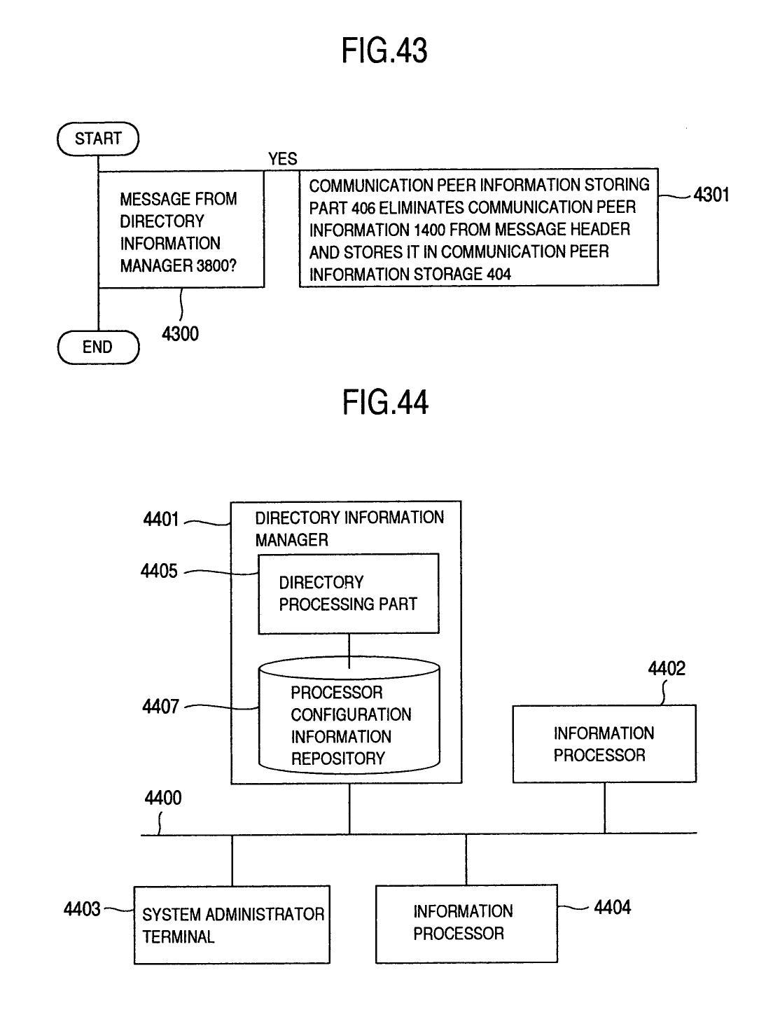

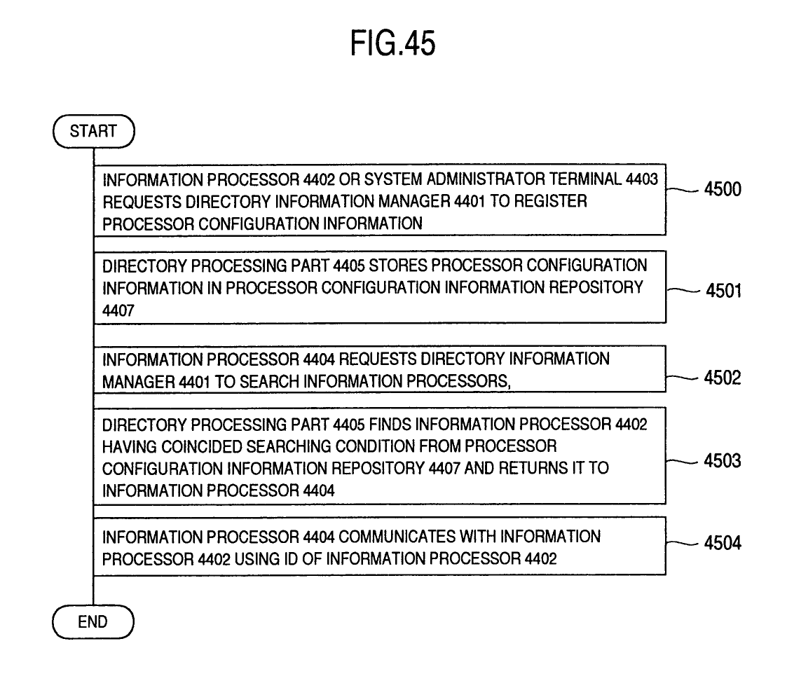

FIG. 43 is a PAD showing a procedure of communication peer information storing operation in the present embodiment. With respect to the communication peer information storing operation of the step 803, it is judged at a step 4300 whether or not the message was sent from the directory information manager 3800, as shown in the PAD of FIG. 43. If the message was sent from the directory information manager 3800, then the communication peer information storing part 406 remove the communication peer information from the message and stores it in the communication peer information storage 404 at a step 4301.

The receive message at the steps 804 to 807 is a notification message from the directory information manager 3800 to the communication managing part 110, and has no relationship with the object-inherent processing part 401. Therefore the message causes no operation and the above operation is terminated.

As has been mentioned above, the directory information manager centralizingly manages the information processors, each information processor can easily grasp the system condition, and the adaptation of the information processors to a change in the system condition can be fully carried out through the directory information manager. As a result, it becomes unnecessary for individual developers relating to the object-inherent processing to program the respective information processors in order to cope with the system change and also becomes unnecessary to add a change to the existing object.

As has been mentioned above, in accordance with the distributed system control methods of the foregoing embodiments, when it is desired to send a message, the directory information is acquired from the directory information manager and the message transmission is carried out on the basis of the directory information. Therefore the change of the communication peer, communication contents and execution method can be dynamically realized without changing the object and the information processors in the distributed system can be centralizedly managed.

In the present invention, in this way, when it is desired to send a message, since the directory information is acquired from the directory information manager and the message transmission is carried out on the basis of the directory information; the change of the communication peer, communication contents and execution method can be dynamically realized without changing the object and the information processors in the distributed system can be centralizedly managed.

What is claimed is:

1. A distributed system control method for controlling operation of a distributed system having a plurality of information processors and a single directory information manager connected therein, comprising the steps of:
creating a message addressed from first one to second of the plurality of information processors in the distributed system;
issuing a request from said first information processor to said directory information manager to cause the directory information manager to search for directory information as management information for control of operation of said respective information processors in the distributed system;
reading out said directory information in said directory information manager and sending said directory information to said first information processor; and
controlling sending operation of said created message on the basis of said directory information received from said directory information manager in said first information processor.

2. A distributed system control method as set forth in claim 1, wherein said directory information includes publish/subscribe information indicative of the other information processors which receive the message to be transferred between the information processors offering a specific service, and said created message is sent also to the other information processors on the basis of said publish/subscribe information.

3. A distributed system control method as set forth in claim 1, wherein said directory information includes service control information for control of operational modes of the information processors belonging to the specific service, and when it is desired to send said created message, the operational modes of the information processors belonging to the specific service are controlled on the basis of said service control information.

4. A directory information manager for managing information for control of operation of a distributed system having a plurality of information processors connected therein, comprising:
a directory information repository for storing therein directory information as management information for control of operations of said plurality of information processors in said distributed system; and
directory processor for reading out the directory information requested by any one of said information processors from said directory information repository and sending the read-out directory information to said information processor.

5. An information processor to be connected to a distributed system as one of a plurality of information processors, said system also having a single directory information manager connected therein, comprising:
object-inherent processor for creating a message addressed to the information processors in said distributed system; and
communication management processor for requesting said directory information manager to search for directory information as management information for control of operations of the information processors in said distributed system and controlling sending operation of the message created by said object-inherent processor on the basis of said directory information received from said directory information manager.
